(19) United States
(12) Patent Application Publication
(10) Pub. No.: US 2023/0026039 A1
(43) Pub. Date: Jan. 26, 2023

(54) Machine Direction Oriented Polyethylene Films

(71) Applicant: ExxonMobil Chemical Patents, Inc., Baytown, TX (US)

(72) Inventors: Nino RUOCCO, Houston, TX (US); Patrick BRANT, Seabrook, TX (US); Matthew W. HOLTCAMP, Huffman, TX (US); Xiao Mei SHI, Shanghai (CN); Tamara L. BLANTON, Nassau Bay, TX (US)

(21) Appl. No.: 17/756,930

(22) PCT Filed: Dec. 9, 2020
(86) PCT No.: PCT/US2020/064052

§ 371 Date: Jun. 6, 2022

Related U.S. Application Data
(60) Provisional application No. 62/945,754, filed on Dec. 9, 2019.

(51) Int. Cl. C08L 23/08; C08K 5/526; C08K 5/138; B29C 48/00; B29C 48/08; B29C 55/00; B29C 55/06

(52) U.S. Cl. CPC C08L 23/0815; C08K 5/526; C08K 5/138; B29C 48/0018; B29C 48/022; B29C 48/08; B29C 55/005; B29C 55/06; B29K 2023/06; B29K 2995/0097; B29K 2995/0063; B29L 2007/008

(57) ABSTRACT

This invention relates to an oriented polyethylene film comprising polyethylene having: (A) a melt flow index of 1.0 g/10 min or more, (B) a density of 0.90 g/cm³ to less than 0.940 g/cm³, (C) a g′_{LCB} of greater than 0.8, (D) ratio of comonomer content at Mz to comonomer content at Mw is greater than 1.0, (E) ratio of comonomer content at Mn to comonomer content at Mw is greater than 1.0, and (F) a ratio of the g′_{LCB} to the g′_{Zave} is greater than 1.0, where the film has a 1% secant in the transverse direction of 70,000 psi or more and Dart Drop of 350 g/mil or more.

### CROSS-REFERENCE TO RELATED APPLICATIONS

This invention claims the benefit of U.S. Provisional application No. 62/945,754, filed on Dec. 9, 2019, entitled “Machine Direction Oriented Polyethylene Films”, the entirety of which is incorporated by reference herein.

### FIELD OF INVENTION

The present disclosure relates to machine direction oriented polyethylene films.

### BACKGROUND

It is desirable for plastic bags, particularly those used to contain bulk waste materials, to be resistant to damage by puncture and yielding under stress. Films with high strength characteristics, including tensile strength and puncture toughness, are needed in such applications. Additionally, films having a thinner thickness that exhibit high strength provide a better cost-performance relationship for the consumer. Currently, such bags are most commonly produced from polyolefin films, including polyethylene and polypropylene films.

For many years, high performance polyolefins, such as low density polyethylene (LDPE), have been readily available at a low manufacturing cost sufficient to justify commercial use in food packaging as well as trash bags, including heavy duty garbage bags, leaf bags, and trash can liners. The use of polyethylene, more particularly low density polyethylene, allows for the production of bags with remarkably thin gauge and flexibility while maintaining high strength characteristics such as puncture and tensile strength.

More recently, linear low density polyethylene (LLDPE) has been used in place of conventional highly branched LDPE in many film applications, including bags. LLDPE is widely recognized as being tougher and stronger than LDPE, thus contributing to reduced bag failures, including punctures and splitting under stress. In particular, LLDPEs made with metallocene or single site catalysts, and LLDPEs containing hexene and/or octene comonomers have been used to provide improved toughness. However, films made from LDPE have limited impact resistance compared to the catalyst produced LLDPEs. Likewise, LLDPE's have a high impact resistance but are difficult to process. Blending these resins often creates a composition that is easier to process, but the desirable toughness of the LLDPE's is reduced. What would be desirable is to improve the processability of LLDPE-type resins while maintaining high tear and toughness in the films produced from such resins. Polyethylene films are of recent interest in the field because polyethylene is more readily recycled. However, polyethylene tends to have a higher crystallinity than polypropylene, making it more difficult to down gauge and maintain a suitable balance of stiffness and toughness characteristics.

U.S. Pat. No. 9,068,033 discloses ethylene hexene copolymers having, inter alia, a g′ᵥᵢₛ of less than 0.8, a melt index, 12, of 0.25 to 1.5 g/10 min, that are converted into films.

US patent numbers: U.S. Pat. Nos. 5,955,625; 6,168,826; 6,225,426; 9,266,977; EP 2935367; US patent application publication numbers: US 2008/0233375; US 2016/0031191; US 2015/0258756; US 2009/0286024; US 2018/0237558; US 2018/0237559; US 2018/0237554; US 2018/0319907; US 2018/0023788; WIPO patent application publication numbers: WO 2017/127808; WO 2015/154253; WO 2015/138096; WO 1997/022470; Japanese Pat. App. Pub. No. 2016/147430; Kim, W. N. et al. (1994) “Morphology and Mechanical Properties of Biaxially Oriented Films of Polypropylene and HDPE Blends,” Appl. Polym. Sci., v.54(11), pp. 1741-1750; Ratta, V. et al. (2001) “Structure-Property-Processing Investigations of the Tenter-Frame Process for Making Biaxially Oriented HDPE Film. I. Base Sheet and Draw Along the MD” Polymer, v.42(21), pp. 9059-9071; Ajji, A. et al. (2004) “Biaxial Stretching and Structure of Various LLDPE Resins” Polym. Eng. Sci., v.44(2), pp. 252-260; Ajji, A. et al. (2006) “Biaxial Orientation in LLDPE Films: Comparison of Infrared Spectroscopy, X-ray Pole Figures, and Birefringence Techniques,” Polym. Eng. Sci., v.46(9), pp. 1182-1189; Uehara, H et al. (2004) “Stretchability and Properties of LLDPE. Blends for Biaxially Oriented Film,” Intern. Polymer Processing, v.19(2), pg. 163; Bobovitch, A. L. et al. (2006) “Mechanical Properties Stress-Relaxation, and Orientation of Double Bubble Biaxially Oriented Polyethylene Films,” J. Appl. Poly. Sci., v.100(5), pp. 3545-3553; Sun, T. et al. (2001) Macromolecules, v.34(19), pp. 6812-6820; Stadelhofer, J. et al. (1975) “Darstellung und Eigenschaften von Alkylmetallcyclo-Pentadienderivaten des Aluminiums, Galliums und Indiums,” Jrnl. Organometallic Chem., v.84, pp. C1-C4 and Chen, Q. et al. (2019) “Structure Evolution of Polyethylene in Sequential Biaxial Stretching along the First Tensile Direction,” Ind. Eng. Chem. Res., V.58, pp. 12419-12430.

### SUMMARY OF THE INVENTION

The present disclosure relates to machine direction oriented polyethylene films comprising polyethylene, such as linear low density polyethylene (LLDPE), with properties that improve processability while maintaining toughness and high impact resistance.

This invention relates to a machine direction oriented polyethylene film comprising polyethylene having: (A) a melt flow index of 1.0 g/10 min or more, (B) a density of 0.90 g/cm³ to less than 0.940 g/cm³, (C) a g′_{LCB} of greater than 0.8, (D) ratio of comonomer content at Mz to comonomer content at Mw is greater than 1.0, (E) ratio of comonomer content at Mn to comonomer content at Mw is greater than 1.0, and (F) a ratio of the g′_{LCB} to the g′_{Zave} is greater than 1.0, where the film has a 1% secant in the transverse direction of 70,000 psi or more and Dart Drop of 350 g/mil or more.

The present disclosure also relates to compositions comprising: a machine direction oriented film comprising a polyethylene having: (A) a I₂ of 1.5 g/10 min to 2.1 g/10 min (or 1.6 g/10 min to 2.0 g/10 min, or 1.7 g/10 min to 1.9 g/10 min); (B) a density of 0.91 g/cm³ to 0.93 g/cm³ (or 0.912 g/cm³ to 0.927 g/cm³, or 0.915 g/cm³ to 0.925 g/cm³); (C) a g′_{LCB} of greater than 0.8 (or from 0.81 to 0.95), (D) a ratio of comonomer content at Mz-LS to comonomer content at Mw-LS (CCMz/CCMw) of greater than 1.0, or from 1.1 to 3.5, or from 1.3 to 3.0, (E) a ratio of comonomer content at Mn-LS to comonomer content at Mw-LS (CCMn/CCMw) of greater than 1.0, or from 1.1 to 3.5, or from 1.3 to 3.0, and (F) a ratio of the g′_{LCB} to the g′_{Zave} is greater than 1.0, or from 1.1 to 10.

The present disclosure also relates to methods comprising: producing a polymer melt comprising polymer described above; extruding a film from the polymer melt; and stretching the film in a machine direction at a temperature below the melting temperature of the polyethylene to produce a machine direction oriented (MDO) polyethylene film.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is a GPC-4D print out of example I-1 with a table of various characteristics of said printout.

FIG. 2 is a graph of the weight fraction versus molecular weight (LS), comonomer content (wt %) versus molecular weight and branching index versus molecular weight for Example C-1.

FIG. 3 is a graph of the weight fraction versus molecular weight (LS), comonomer content (wt %) versus molecular weight and branching index versus molecular weight for Example I-1.

FIG. 4 is a graph of the weight fraction versus molecular weight (LS), comonomer content (wt %) versus molecular weight and branching index versus molecular weight for Example I-2.

FIG. 5 is a diagram of the extruder and rollers used to make the machine direction oriented (MDO) polyethylene films of the present examples.

FIG. 6 is a plot of the 1% secant modulus in the machine direction as a function of the stretch ratio for comparative and inventive films described herein.

FIG. 7 is a plot of the tensile strength per mil in the machine direction as a function of the stretch ratio for comparative and inventive films described herein.

### DETAILED DESCRIPTION

The present disclosure relates to machine direction oriented polyethylene films comprising a LLDPE with well-defined properties that improve processability while maintaining mechanical properties as tensile strength. More specifically, the polyethylene of the present disclosure has: (A) a melt flow index of 1.0 g/10 min or more, (B) a density of 0.90 g/cm³ to less than 0.940 g/cm³, (C) a g′_{LCB} of greater than 0.8, (D) ratio of comonomer content at Mz to comonomer content at Mw is greater than 1.0, (E) ratio of comonomer content at Mn to comonomer content at Mw is greater than 1.0, and (F) a ratio of the g′_{LCB} to the g′_{Zave} is greater than 1.0, where the film has a 1% secant in the transverse direction of 70,000 psi or more and Dart Drop of 350 g/mil or more. The polyethylene may be further characterized by having: (A) a melt flow index of 1.5 g/10 min to 2.1 g/10 min, (B) a density of 0.91 g/cm³ to 0.93 g/cm³, (G) a z-average molecular weight of 300,000 g/mol or greater, and (H) a long chain branching (g′_{LCB}) value of 0.8 to 0.9. Such a LLDPE is easier to process and stretch. As a result, the extruded polyethylene films can be stretched to a greater extent and achieve the physical properties like toughness of thicker films produced with other LLDPEs.

### Definitions and Test Methods

Unless otherwise indicated, room temperature is 25° C.

An “olefin,” alternatively referred to as “alkene,” is a linear, branched, or cyclic compound of carbon and hydrogen having at least one double bond.

A “polymer” has two or more of the same or different mer units. A “homopolymer” is a polymer having mer units that are the same. The term “polymer” as used herein includes, but is not limited to, homopolymers, copolymers, terpolymers, etc. The term “polymer” as used herein also includes impact, block, graft, random, and alternating copolymers. The term “polymer” shall further include all possible geometrical configurations unless otherwise specifically stated. Such configurations may include isotactic, syndiotactic, and random symmetries.

As used herein, unless specified otherwise, the term “copolymer(s)” refers to polymers formed by the polymerization of at least two different monomers (i.e., mer units). For example, the term “copolymer” includes the copolymerization reaction product of propylene and an alpha-olefin, such as ethylene, 1-hexene. A “terpolymer” is a polymer having three mer units that are different from each other. Thus, the term “copolymer” is also inclusive terpolymers and tetrapolymers, such as, for example, the copolymerization product of a mixture of ethylene, propylene, 1-hexene, and 1-octene.

“Different” as used to refer to monomer mer units indicates that the mer units differ from each other by at least one atom or are different isomerically. An “ethylene polymer” or “ethylene copolymer” is a polymer or copolymer comprising at least 50 mole % ethylene derived units, a “propylene polymer” or “propylene copolymer” is a polymer or copolymer comprising at least 50 mole % propylene derived units, and so on. For purposes of this invention, a polyethylene is an ethylene polymer.

As used herein, when a polymer is referred to as “comprising, consisting of, or consisting essentially of” a monomer, the monomer is present in the polymer in the polymerized/derivative form of the monomer. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer.

A “low density polyethylene,” LDPE, is an ethylene polymer having a density of more than 0.90 g/cm³ to less than 0.94 g/cm³; this class of polyethylene includes copolymers made using a heterogeneous catalysis process (often identified as linear low density polyethylene, LLDPE) and homopolymers or copolymers made using a high-pressure/free radical process (often identified as LDPE). A “linear low density polyethylene,” LLDPE, is an ethylene polymer having a density of more than 0.90 g/cm³ to less than 0.94 g/cm³, preferably from 0.910 to 0.935 g/cm³ and typically having a g′_{LCB} of 0.95 or more. A “high density polyethylene” (“HDPE”) is an ethylene polymer having a density of 0.94 g/cm³ or more.

Density, reported in g/cm³, is determined in accordance with ASTM 1505-10 (the plaque is and molded according to ASTM D4703-10a, procedure C, plaque preparation, including that the plaque is conditioned for at least forty hours at 23° C. to approach equilibrium crystallinity), where the measurement for density is made in a density gradient column.

As used herein, Mn is number average molecular weight, Mw is weight average molecular weight, and Mz is z-average molecular weight. Polydispersity index (PDI) is defined to be Mw divided by Mn. Unless otherwise noted, all molecular weights (e.g., Mw, Mn, Mz) are reported in units of g/mol.

Gel Permeation Chromatography (GPC) is a liquid chromatography technique used to measure the molecular weight and polydispersity of polymers.

Unless otherwise indicated, the distribution and the moments of molecular weight (e.g., Mw, Mn, Mz, Mw/Mn) and the comonomer content (e.g., C₂, C₃, C₆) is determined by using a high temperature Gel Permeation Chromatography (Polymer Char GPC-IR) equipped with a multiple-channel band-filter based Infrared detector IR5, an 18-angle light scattering detector and a viscometer. Three Agilent PLgel 10-μm Mixed-B LS columns are used to provide polymer separation. Aldrich reagent grade 1,2,4-trichlorobenzene (TCB) with 300 ppm antioxidant butylated hydroxytoluene (BHT) is used as the mobile phase. The TCB mixture is filtered through a 0.1-μm Teflon filter and degassed with an online degasser before entering the GPC instrument. The nominal flow rate is 1.0 mL/min, and the nominal injection volume is 200 μL. The whole system including transfer lines, columns, and detectors is contained in an oven maintained at 145° C. The polymer sample is weighed and sealed in a standard vial with 80-pL flow marker (heptane) added to it. After loading the vial in the autosampler, polymer is dissolved in the instrument with 8 mL added TCB solvent. The polymer is dissolved at 160° C. with continuous shaking for about 1 hour for polyethylene samples or about 2 hours for polypropylene samples. The TCB densities used in concentration calculation is 1.463 g/ml at room temperature and 1.284 g/mL at 145° C. The sample solution concentration is from 0.2 to 2.0 mg/mL, with lower concentrations being used for higher molecular weight samples. The concentration (c), at each point in the chromatogram is calculated from the baseline-subtracted IR5 broadband signal intensity (1), using the following equation: c=βI, where β is the mass constant. The mass recovery can be calculated from the ratio of the integrated area of the concentration chromatography over elution volume and the injection mass, which is equal to the pre-determined concentration multiplied by injection loop volume. The conventional molecular weight (IR molecular weight) is determined by combining universal calibration relationship with the column calibration, which is performed with a series of monodispersed polystyrene (PS) standards ranging from 700 to 10,000,000 gm/mole. The molecular weight at each elution volume is calculated with (1):

$$log M = \frac{log ( {K}_{P S} / K )}{a + 1} + \frac{{a}_{P S} + 1}{a + 1} log {M}_{P S} \qquad EQ . 1$$

where the variables with subscript “PS” stand for polystyrene while those without a subscript are for the test samples. In this method, α_{PS}=0.67 and K_{PS}=0.000175 while a and K for other materials are as calculated and published in literature (Sun, T. et al. (2001) Macromolecules, v.34, pg. 6812), except that for purposes of this invention and claims thereto, α=0.705 and K=0.0002288 for linear propylene polymers, α=0.695 and K=0.000181 for linear butene polymers, a is 0.695 and K is 0.000579*(1−0.0087*w2b+0.000018*(w2b)\hat{ }2) for ethylene-butene copolymer where w2b is a bulk weight percent of butene comonomer, α is 0.695 and K is 0.000579*(1−0.0075*w2b) for ethylene-hexene copolymer where w2b is a bulk weight percent of hexene comonomer, and a is 0.695 and K is 0.000579*(1−0.0077*w2b) for ethylene-octene copolymer where w2b is a bulk weight percent of octene comonomer, and α=0.695 and K=0.000579 for all other linear ethylene polymers. Concentrations are expressed in g/cm³, molecular weight is expressed in g/mole, and intrinsic viscosity (hence K in the Mark-Houwink equation) is expressed in dL/g, unless otherwise noted.

The comonomer composition is determined by the ratio of the IR5 detector intensity corresponding to CH₂ and CH₃ channel calibrated with a series of polyethylene and propylene homo/copolymer standards whose nominal value are predetermined by NMR or FTIR. In particular, this provides the methyls per 1,000 total carbons (CH₃/1000TC) as a function of molecular weight. The short-chain branch (SCB) content per 1000TC (SCB/1000TC) can be then computed as a function of molecular weight by applying a chain-end correction to the CH₃/1000TC function, assuming each chain to be linear and terminated by a methyl group at each end. The weight % comonomer can be then obtained from the following expression in which f is 0.3, 0.4, 0.6, 0.8, and so on for C₃, C₄, C₆, C₈, and so on co-monomers, respectively:

w2=f*SCB/1000TC EQ. 2

The bulk composition of the polymer from the GPC-IR and GPC-4D analyses is obtained by considering the entire signals of the CH₃ and CH₂ channels between the integration limits of the concentration chromatogram. First, the following ratio is obtained.

$$Bulk IR ratio = \frac{Area of {CH}_{3} signal with in integration limits}{Area of {CH}_{2} signal within integration limits} \qquad EQ . 3$$

Then the same calibration of the CH₃ and CH₂ signal ratio, as mentioned previously in obtaining the CH₃/1000TC as a function of molecular weight, is applied to obtain the bulk CH₃/1000TC. A bulk methyl chain ends per 1000TC (bulk CH₃end/1000TC) is obtained by weight-averaging the chain-end correction over the molecular-weight range. Then,

w2b=f*bulk CH3/1000TC EQ. 4

bulk SCB/1000TC=bulk CH3/1000TC−bulk CH3end/1000TC EQ.5

and bulk SCB/1000TC are converted to bulk w2 in the same manner as described above.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972):

$$\frac{{K}_{o} c}{Δ R ( θ )} = \frac{1}{M P ( θ )} + 2 {A}_{2} c \qquad EQ . 6$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and K_{O} is the optical constant for the system:

$${K}_{o} = \frac{4 {π}^{2} {{n}^{2} ( d n / d c )}^{2}}{{λ}^{4} {N}_{A}} {K}_{o} = \frac{4 {π}^{2} {{n}^{2} ( d n / d c )}^{2}}{{λ}^{4} {N}_{A}} \qquad EQ . 7$$

where N_{A} is Avogadro's number, and (dn/dc) is the refractive index increment for the system, n=1.500 for TCB at 145° C., and λ=665 nm. For analyzing ethylene homopolymers, ethylene-hexene copolymers, and ethylene-octene copolymers, dn/dc=0.1048 ml/mg and A₂=0.0015; for analyzing ethylene-butene copolymers, dn/dc=0.1048*(1−0.00126*w2) ml/mg and A₂=0.0015 where w2 is weight percent butene comonomer, for all other ethylene polymers dn/dc=0.1048 ml/mg and A₂=0.0015.

A high temperature viscometer, such as those made by Technologies, Inc. or Viscotek Corporation, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, η_{S}, for the solution flowing through the viscometer is calculated from their outputs. The intrinsic viscosity, [η], at each point in the chromatogram is calculated from the equation [η]=η_{S}/c, where c is concentration and is determined from the IR5 broadband channel output. The viscosity MW at each point is calculated as M=K _{PS}M ^{α}^{_{Ps}}⁺¹/[η], where α_{PS} is 0.67 and K_{PS} is 0.000175. The average intrinsic viscosity, [symbol] [η] [symbol] of the sample is calculated by:

$$〈 [ η ] 〉 = \frac{\sum {{c}_{i} [ η ]}_{t}}{\sum {c}_{i}} \qquad EQ . 9$$

where the summations are over the chromatographic slices, i, between the integration limits.

The long chain branching index (g′_{LCB}, also referred to as g′ᵥᵢₛ) is defined as

$${g}_{LCB}^{′} = \frac{〈 [ η ] 〉}{K {〈 {M}_{IR} 〉}^{α}} \qquad EQ . 8$$

where [symbol] M_{IR} [symbol] is the viscosity average molecular weight calibrated with polystyrene standards, K and a are for the reference linear polymer, which are as calculated and published in literature (Sun, T. et al. (2001) Macromolecules, v.34, pg. 6812), except that for purposes of this invention and claims thereto, α=0.705 and K=0.0002288 for linear propylene polymers, α=0.695 and K=0.000181 for linear butene polymers, α is 0.695 and K is 0.000579* (1−0.0087*w2b+0.000018*(w2b)\hat{ }2) for ethylene-butene copolymer where w2b is a bulk weight percent of butene comonomer, a is 0.695 and K is 0.000579*(1−0.0075*w2b) for ethylene-hexene copolymer where w2b is a bulk weight percent of hexene comonomer, and a is 0.695 and K is 0.000579*(1−0.0077*w2b) for ethylene-octene copolymer where w2b is a bulk weight percent of octene comonomer, and α=0.695 and K=0.0005 for all other linear ethylene polymers.

The g′_{Mz} is determined by selecting the g′ value at the Mz value on the GPC-4D trace produced by the GPC method described above. The Mz value is obtained from the LS detector. For example, if the Mz-LS is 300,000 g/mol, the value on the g′ trace on the GPC-4D graph at 300,000 g/mol is used. The g′_{Mw} is determined by selecting the g′ value at the Mw value on the GPC-4D trace. The Mw value is obtained from the LS detector. For example, if the Mw-LS is 100,000 g/mol, the value on the g′ trace on the GPC-4D graph at 100,000 g/mol is used. The g′_{Mn} is determined by selecting the g′ value at the Mn value on the GPC-4D trace. The Mz value is obtained from the LS detector. For example, if the Mn-LS is 50,000 g/mol, the value on the g′ trace on the GPC-4D graph at 50,000 g/mol is used.

Comonomer contents at the Mw, Mn, and Mz are determined by GPC-4D using the molecular weight values obtained by the LS detector.

The small amplitude oscillatory shear (SAOS) measurements were made on the Anton Paar MCR702 Rheometer. Samples were compression molded at 177° C. for 15 minutes (including cool down under pressure). Then, a 25 mm testing disk specimen was die cut from the resulting plaques. Testing was conducted using a 25 mm parallel plate geometry. Amplitude sweeps were performed on all samples to determine the linear deformation regime. For amplitude sweep, the strain was set from 0.1% to 100% with a frequency of 6 rad/sec and temperature of 190° C. Once the linearity was established, frequency sweeps were performed to determine the complex viscosity profile from 0.01 rad/s to 500 rad/s at T=190° C. under 5% strain.

In order to quantify the shear-like rheological behavior, we define the degree of shear thinning (DST) parameter. The DST was measured by the following expression:

$$D S T = \frac{[ {η}_{0.01} - {η}_{50} ]}{{η}_{0.01}} \qquad EQ . 10$$

Where η_{0.01} and η₅₀ are the complex viscosities at frequencies of 0.01 rad/s and 50 rad/s, respectively, measured at 190° C. The DST parameter helps to better differentiate and highlight the branching character of the samples.

The tensile evolution of the transient extensional viscosity was investigated by MCR501 rheometer available from Anton Paar with controlled operational speed. The linear viscoelastic envelope (LVE) is obtained from start-up steady shear experiments. Strain hardening is defined as a rapid and abrupt leveling-off of the extensional viscosity from the linear viscoelastic behavior. Therefore, this nonlinear behavior was quantified by the strain hardening ratio (SHR), which is defined as the ratio of the maximum transient extensional viscosity (η_{E*) at} 1 s⁻¹ over the respective value at 0.1 s⁻¹:

$$S H R = \frac{{η}_{E}^{*} ( ε = 1 {s}^{- 1} , t )}{{η}_{E}^{*} ( ε = 0.1 {s}^{- 1} , t )} \qquad EQ . 11$$

The value at 0.1 s⁻¹ was preferred to LVE because of the choice to adopt only transient extensional and not start-up steady shear data in the treatment. Whenever the SHR is greater than 1, the material exhibits strain hardening.

The differential scanning calorimetry (DSC) measurements were performed with TA Instruments' Discovery 2500. Melting point or melting temperature (Tm), crystallization temperature (Tc), and heat of fusion or heat flow (ΔH_{f} or H_{f}) were determined using the following DSC procedure. Samples weighing approximately 2 mg to 5 mg were sealed in aluminum hermetic pan. Heat flow was normalized with the sample mass. The DSC runs were ramped from 0° C. to 200° C. at a rate of 10° C./min After equilibration for 45 sec, the samples were cooled down at 10° C./min to 0° C. Both first and second thermal cycles were recorded. Unless otherwise specified, DSC measurements are based on the 2^{nd} crystallization and melting ramps. The melting temperature (Tₘ) and crystallization temperature (T_{c}) were calculated by integrating the melting and crystallization peaks (area below the curves).

As used herein, a “peak” occurs where the first derivative of the corresponding curve changes sign from positive value to negative value. As used herein, a “valley” occurs where the first derivative of the corresponding curve changes from a negative value to a positive value.

Melt flow index (MFI) or I₂ was measured according to ASTM 1238-13 on a Goettfert MI-4 Melt Indexer. Testing conditions were set at 190° C. and 2.16 kg load. An amount of 5 g to 6 g of sample was loaded into the barrel of the instrument at 190° C. and manually compressed. Afterwards, the material was automatically compacted into the barrel by lowering all available weights onto the piston to remove all air bubbles. Data acquisition was started after a 6 min pre-melting time. Also, the sample was pressed through a die of 8 mm length and 2.095 mm diameter.

As used herein, the terms “machine direction” and “MD” refer to the stretch direction in the plane of the film.

As used herein, the terms “transverse direction” and “TD” refer to the perpendicular direction in the plane of the film relative to the MD.

As used herein, the term “extruding” and grammatical variations thereof refer to processes that includes forming a polymer and/or polymer blend into a melt, such as by heating and/or sheer forces, and then forcing the melt out of a die in a form or shape such as in a film. Most any type of apparatus will be appropriate to effect extrusion such as a single or twin-screw extruder, or other melt-blending device as is known in the art and that can be fitted with a suitable die.

Gauge of a film was determined by ASTM D6988-13.

1% secant modulus and tensile properties, including yield strength, elongation at yield, tensile strength, and elongation at break, were determined by ASTM D882-10, with the following modifications: a jaw separation of 5 inches and a sample width of 1-inch is used. The index of stiffness of thin films is determined by manually loading the samples with slack and pulling the specimen at a rate of jaw separation (crosshead speed) of 0.5 inches per minute to a designated strain of 1% of its original length and recording the load at these points.

The calculation procedures are as follows:

Tensile strength is calculated as a function of the maximum force in pounds divided by the cross-sectional area of the specimen. Ultimate Tensile=Maximum Force/Cross-Sectional Area.

Yield strength is calculated as a function of the force at yield divided by the cross-sectional area of the specimen. Yield Strength=Force at Yield/Cross-Sectional Area.

Elongation is calculated as a function of the increase in length divided by the original length times 100. Elongation=Increase in Length/Original Length×100%.

Yield point is the first point in which there is an increase in strain (elongation) and none in stress (force). The yield is determined by a 2% off-set method.

Tensile at 100% Elongation is calculated as a function of the force at 100% elongation divided by the cross-sectional area of the specimen. Tensile at 100% Elongation=Force at 100% Elongation/Cross-Sectional Area.

Tensile at 200% Elongation is calculated as a function of the force at 200% elongation divided by the cross-sectional area of the specimen. Tensile at 200% Elongation=Force at 200% Elongation/Cross-Sectional Area.

The 1% secant modulus is measured of the material stiffness and is calculated as a function of the total force at 1% extension, divided by the cross-sectional area times 100 and reported in PSI units. 1% Secant Modulus=Load at 1% Elongation/(Average Thickness (Inches)×Width)×100.

Elmendorf tear was determined by ASTM D1922-15.

Transparency was determined by ASTM D1746-15.

Haze was determined by ASTM D1003-13.

Gloss was determined by ASTM D2457-13.

Dart drop was determined by phenolic Method A per ASTM D1709-16ae1.

Puncture properties including peak force, peak force per mil, break energy, and break energy per mil were determined by ASTM D5748, with the following modifications. Any film sample ˜1 mil thick is placed in a circular clamp approximately 4 inches wide. A stainless steel custom-made plunger/probe with a ¾″ tip and two 0.25 mil slip sheets are pressed through the specimen at a constant speed of 10 in/min Results are obtained after failure from five different locations chosen on the standard film strip and averaged.

As used herein, a measurement per mil is calculated by dividing the value of the measurement by the value of the thickness of the film. For example, a 2 mil film having a peak force of 50 lbs has a peak force per mil of 25 lbs/mil.

Shrink (in both Machine (MD) and Transverse (TD) directions) was measured as the percentage decrease in length of a 100 cm circle of film along the MD and TD, under a heat gun (Model HG-501A) set with an average temperature of 750° F. The heat gun was centered two inches over the sample and heat was applied until each specimen stopped shrinking

Water vapor transmission rate (WVTR) performed on a MOCON Permatran W-700 and W3/61 obtained from MOCON, Inc. using ASTM F1249 at 100° F. (37.8° C.) and 100% relative humidity where samples were loaded without specific orientation.

### Polyethylene Synthesis

For the purposes of this invention and the claims thereto, the new numbering scheme for the Periodic Table Groups is used as described in Chemical and Engineering News, v.63(5), pg. 27 (1985). Therefore, a “group 4 metal” is an element from group 4 of the Periodic Table, e.g. Hf, Ti, or Zr.

The terms “hydrocarbyl radical,” “hydrocarbyl group,” or “hydrocarbyl” may be used interchangeably and are defined to mean a group consisting of hydrogen and carbon atoms only. Preferred hydrocarbyls are C₁-C₁₀₀ radicals that may be linear, branched, or cyclic, and when cyclic, aromatic or non-aromatic. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like, aryl groups, such as phenyl, benzyl naphthyl, and the like.

A “metallocene” catalyst compound is a transition metal catalyst compound having one, two or three, typically one or two, substituted or unsubstituted cyclopentadienyl ligands bound to the transition metal, typically a metallocene catalyst is an organometallic compound containing two π-bound cyclopentadienyl moieties (or substituted cyclopentadienyl moieties).

Substituted or unsubstituted cyclopentadienyl ligands include substituted or unsubstituted cyclopentadienyl, indenyl, fluorenyl, tetrahydro-s-indacenyl, tetrahydro-as-indacenyl, benz[f]indenyl, benz [e]indenyl, tetrahydrocyclopenta [b]naphthalene, tetrahydrocyclopenta[a]naphthalene, and the like.

Unless otherwise indicated, (e.g., the definition of “substituted hydrocarbyl,” etc.), the term “substituted” means that at least one hydrogen atom has been replaced with at least one non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)q-SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halogen, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)q-SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

For purposes of the present disclosure, in relation to metallocene compounds, the term “substituted” means that a hydrogen group has been replaced with a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)q-SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The inventive ethylene-based copolymers useful herein are preferably made in a process comprising contacting ethylene and of one or more C₃ to C₂₀ olefins in at least one gas phase reactor at a temperature in the range of from 60° C. to 90° C. and at a reactor pressure of from 70 kPa to 7,000 kPa, in the presence of a metallocene catalyst system.

Preferred metallocene catalyst systems include an activator and a bridged metallocene compound.

Particularly useful bridged metallocene compounds include those represented by the following formula:

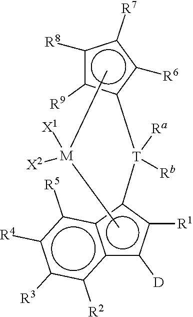

wherein:

M is a group 4 metal, especially zirconium or hafnium;

T is a group 14 atom, preferably Si or C;

D is hydrogen, methyl, or a substituted or unsubstituted aryl group, most preferably phenyl;

R^{a} and R^{b} are independently, hydrogen, halogen, or a C₁ to C₂₀ substituted or unsubstituted hydrocarbyl, and R^{a} and R^{b} can form a cyclic structure including substituted or unsubstituted aromatic, partially saturated, or saturated cyclic or fused ring system;

each X¹ and X² is independently selected from the group consisting of C₁ to C₂₀ substituted or unsubstituted hydrocarbyl groups, hydrides, amides, amines, alkoxides, sulfides, phosphides, halides, dienes, phosphines, and ethers, and X¹ and X² can form a cyclic structure including aromatic, partially saturated, or saturated cyclic or fused ring system;

each of R¹, R², R³, R⁴, and R⁵ is, independently, hydrogen, halide, alkoxide or a C₁ to C₂₀ or C₄₀ substituted or unsubstituted hydrocarbyl group, and any of adjacent R², R³, R⁴, and/or R⁵ groups may form a fused ring or multicenter fused ring systems, where the rings may be substituted or unsubstituted, and may be aromatic, partially unsaturated, or unsaturated; and each of R⁶, R⁷, R⁸, and R⁹ is, each independently, hydrogen or a C₁ to C₂₀ or C₄₀ substituted or unsubstituted hydrocarbyl group, most preferably methyl, ethyl or propyl; and further provided that at least two of R⁶, R⁷, R⁸, and R⁹ are C₁ to C₄₀ substituted or unsubstituted hydrocarbyl groups; wherein “hydrocarbyl” (or “unsubstituted hydrocarbyl”) refers to carbon-hydrogen radicals such as methyl, phenyl, iso-propyl, napthyl, etc. (aliphatic, cyclic, and aromatic compounds consisting of carbon and hydrogen), and “substituted hydrocarbyl” refers to hydrocarbyls that have at least one heteroatom bound thereto such as carboxyl, methoxy, phenoxy, BrCH₃—, NH₂CH₃—, etc.

Preferred metallocene compounds may be represented by the following formula:

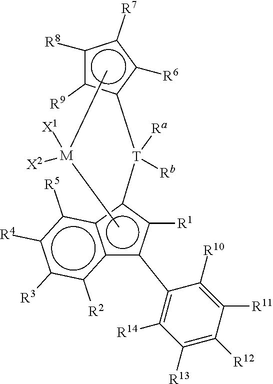

wherein R¹, R², R³, R⁴,R⁵, R⁶, R⁷, R⁸, R⁹, R^{a}, R^{b}, X¹, X², T, and M are as defined above; and R¹⁰, R¹¹, R¹², R¹³, and R¹⁴ are each independently H or a C¹ to C⁴⁰ substituted or unsubstituted hydrocarbyl.

Particularly preferred metallocene compounds useful herein are represented by the formula:

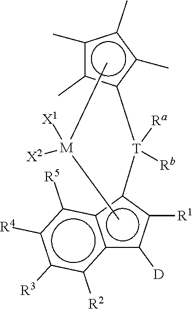

wherein R¹, R², R³, R⁴, R⁵, R^{a}, R^{b}, X¹, X², T, D, and M are as defined above.

In particularly preferred embodiments, metallocene compounds useful herein may be represented by the following structure:

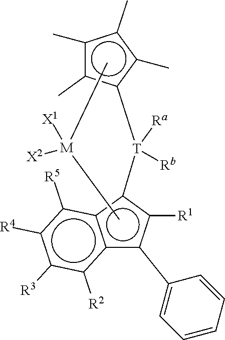

wherein R¹, R², R³, R⁴, R⁵, R^{a}, R^{b}, X¹, X², T, and M are as defined above.

Examples of preferred metallocene compounds include: dimethylsilylene(3-phenyl-1-indenyl)(2,3,4,5-tetramethyl-1-cyclopentadienyl)zirconium dichloride; dimethylsilylene (3-phenyl-1-indenyl) (2,3,4,5-tetramethyl-1-cyclopentadienyl) zirconium methyl; bis(n-propyl ccyclopentadienyl)Hf dimethyl bis(n-propyl cyclopentadienyl)Hf dichloride; and the like.

The polymerization process of the present invention may be carried out using any suitable process, such as, for example, solution, slurry, high pressure, and gas phase. A particularly desirable method for producing polyolefin polymers according to the present invention is a gas phase polymerization process preferably utilizing a fluidized bed reactor. Desirably, gas phase polymerization processes are such that the polymerization medium is either mechanically agitated or fluidized by the continuous flow of the gaseous monomer and diluent. Other gas phase processes contemplated by the process of the invention include series or multistage polymerization processes.

The metallocene catalyst is used with an activator in the polymerization process to produce the inventive polyethylenes. The term “activator” is used herein to be any compound which can activate any one of the metallocene compounds described above by converting the neutral catalyst compound to a catalytically active metallocene compound cation. Preferably the catalyst system comprises an activator. Activators useful herein include alumoxanes or “non-coordinating anion” activators such as boron-based compounds (e.g., tris(perfluorophenyl)borane, or ammonium tetrakis(pentafluorophenyl)borate).

The catalyst systems useful herein can include at least one non-coordinating anion (NCA) activator, such as NCA activators represented by the formula below:

Z_{d}+(A^{d-})

where: Z is (L-H) or a reducible Lewis acid; L is a neutral Lewis base; H is hydrogen;

(L-H) is a Bronsted acid; A^{d-} is a boron containing non-coordinating anion having the charge d-; d is 1, 2, or 3.

The cation component, z_{d}⁺ may include Bronsted acids such as protons or protonated Lewis bases or reducible Lewis acids capable of protonating or abstracting a moiety, such as an alkyl or aryl, from the bulky ligand metallocene containing transition metal catalyst precursor, resulting in a cationic transition metal species.

The activating cation Z_{d}+ may also be a moiety such as silver, tropylium, carboniums, ferroceniums and mixtures, preferably carboniums and ferroceniums. Most preferably Z_{d}+ is triphenyl carbonium. Preferred reducible Lewis acids can be any triaryl carbonium (where the aryl can be substituted or unsubstituted, such as those represented by the formula: (Ar₃C⁺), where Ar is aryl or aryl substituted with a heteroatom, a C₁ to C₄₀ hydrocarbyl, or a substituted C₁ to C₄₀ hydrocarbyl), preferably the reducible Lewis acids in formula (14) above as “Z” include those represented by the formula: (Ph₃C), where Ph is a substituted or unsubstituted phenyl, preferably substituted with C₁ to C₄₀ hydrocarbyls or substituted a C₁ to C₄₀ hydrocarbyls, preferably C₁ to C₂₀ alkyls or aromatics or substituted C₁ to C₂₀ alkyls or aromatics, preferably Z is a triphenylcarbonium.

When Z_{d}⁺ is the activating cation (L-H)_{d}⁺, it is preferably a Bronsted acid, capable of donating a proton to the transition metal catalytic precursor resulting in a transition metal cation, including ammoniums, oxoniums, phosphoniums, silyliums, and mixtures thereof, preferably ammoniums of methylamine, aniline, dimethylamine, diethylamine, N-methylaniline, diphenylamine, trimethylamine, triethylamine, N,N-dimethylaniline, methyldiphenylamine, pyridine, p-bromo N,N-dimethylaniline, p-nitro-N,N-dimethylaniline, phosphoniums from triethylphosphine, triphenylphosphine, and diphenylphosphine, oxomiuns from ethers such as dimethyl ether diethyl ether, tetrahydrofuran and dioxane, sulfoniums from thioethers, such as diethyl thioethers, tetrahydrothiophene, and mixtures thereof.

The anion component A^{d-} includes those having the formula [M^{k+}Qₙ]^{d-} wherein k is 1, 2, or 3; n is 1, 2, 3, 4, 5, or 6 (preferably 1, 2, 3, or 4); n−k=d; M is an element selected from Group 13 of the Periodic Table of the Elements, preferably boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 20 carbon atoms with the proviso that in not more than 1 occurrence is Q a halide. Preferably, each Q is a fluorinated hydrocarbyl group having 1 to 20 carbon atoms, more preferably each Q is a fluorinated aryl group, and most preferably each Q is a pentafluoryl aryl group. Examples of suitable A^{d-} also include diboron compounds as disclosed in U.S. Pat. No. 5,447,895, which is fully incorporated herein by reference.

Illustrative, but not limiting examples of boron compounds which may be used as an activating cocatalyst are the compounds described as (and particularly those specifically listed as) activators in U.S. Pat. No. 8,658,556, which is incorporated by reference herein.

Most preferably, the activator Z_{d}+ (A^{d-}) is one or more of N,N-dimethylanilinium tetra(perfluorophenyl)borate, N,N-dimethylanilinium tetrakis(perfluoronaphthyl)borate, N,N-dimethylanilinium tetrakis(perfluorobiphenyl)borate, N,N-dimethylanilinium tetrakis (3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis (3,5-bis(trifluoromethyl)phenyl)borate, or triphenylcarbenium tetra(perfluorophenyl)borate.

Alternately, preferred activators may include alumoxane compounds (or “alumoxanes”) and modified alumoxane compounds. Alumoxanes are generally oligomeric compounds containing —Al(R¹)—O— sub-units, where R¹ is an alkyl group. Examples of alumoxanes include methylalumoxane (MAO), modified methylalumoxane (MMAO), ethylalumoxane, isobutylalumoxane, and mixtures thereof. Alkylalumoxanes and modified alkylalumoxanes are suitable as catalyst activators, particularly when the abstractable ligand is an alkyl, halide, alkoxide, or amide. Mixtures of different alumoxanes and modified alumoxanes may also be used. It may be preferable to use a visually clear methylalumoxane. A cloudy or gelled alumoxane can be filtered to produce a clear solution or clear alumoxane can be decanted from the cloudy solution. Another useful alumoxane is a modified methylalumoxane (MMAO) cocatalyst type 3A (commercially available from Akzo Chemicals, Inc. under the trade name Modified Methylalumoxane type 3A, disclosed in U.S. Pat. No. 5,041,584). Preferably of this invention, the activator is an alkylalumoxane, preferably methylalumoxane or isobutylalumoxane, most preferably methylalumoxane.

Preferably, the activator is supported on a support material prior to contact with the metallocene compound. Also, the activator may be combined with the metallocene compound prior to being placed upon a support material. Preferably, the activator may be combined with the metallocene compound in the absence of a support material.

In addition to activator compounds, cocatalysts may be used. Aluminum alkyl or organometallic compounds which may be utilized as cocatalysts (or scavengers) include, for example, triethylaluminum, tri-isobutylaluminum, tri-n-hexylaluminum, tri-n-octylaluminum, diethyl aluminum chloride, dibutyl zinc, diethyl zinc, and the like.

Preferably, the catalyst system comprises an inert support material. Preferably, the supported material is a porous support material, for example, talc, and inorganic oxides. Other support materials include zeolites, clays, organoclays, or any other organic or inorganic support material, or mixtures thereof.

Preferably, the support material is an inorganic oxide in a finely divided form. Suitable inorganic oxide materials for use in metallocene compounds herein include Groups 2, 4, 13, and 14 metal oxides such as silica, alumina, and mixtures thereof. Other inorganic oxides that may be employed, either alone or in combination, with the silica or alumina are magnesia, titania, zirconia, and the like. Other suitable support materials, however, can be employed, for example, finely divided functionalized polyolefins such as finely divided polyethylene. Particularly useful supports include magnesia, titania, zirconia, montmorillonite, phyllosilicate, zeolites, talc, clays, and the like. Also, combinations of these support materials may be used, for example, silica-chromium, silica-alumina, silica-titania, and the like. Preferred support materials include Al₂O₃, ZrO₂, SiO₂, and combinations thereof, more preferably SiO₂, Al₂O₃, or SiO₂/Al₂O₃.

The supported catalyst system may be suspended in a paraffinic agent, such as mineral oil, for easy addition to a reactor system, for example a gas phase polymerization system.

Processes and catalyst compounds useful in making the polyethylene useful herein are further described in U.S. Pat. Nos. 9,266,977, 9,068,033, 6,225,426, and US 2018/0237554, all of which are incorporated herein by reference.

### Polyethylene

The polyethylene may be an ethylene homopolymer or an ethylene copolymer, such as ethylene-alphaolefin (preferably C₃ to C₂₀) copolymers (such as ethylene-butene copolymers, ethylene-hexene copolymers, and/or ethylene-octene copolymers) having an Mw/Mn of greater than 1 to 4 (preferably greater than 1 to 3). Unless otherwise specified, polyethylene encompasses both ethylene homopolymers and ethylene copolymers.

The comonomer content (cumulatively if more than one comonomer is used) of the polyethylene can be 0 mol % (i.e., a homopolymer) to 25 mol % (or 0.5 mol % to 20 mol %, or 1 mol % to 15 mol %, or 3 mol % to 10 mol %, or 6 to 10 mol %) with the balance being ethylene.

Accordingly, the ethylene content of the polyethylene can be 75 mol % or more ethylene (or 75 mol % to 100 mol %, or 80 mol % to 99.5 mol %, or 85 mol % to 99 mol %, or 90 mol % to 97 mol %, or 4 to 90 mol %).

Alternately, the comonomer content (cumulatively if more than one comonomer is used) in the polyethylene can be 0 wt % (i.e., a homopolymer) to 25 wt % (or 0.5 wt % to 20 wt %, or 1 wt % to 15 wt %, or 3 wt % to 10 wt %, or 6 to 10 wt %) with the balance being ethylene. Accordingly, the ethylene content of the polyethylene can be 75 wt % or more ethylene (or 75 wt % to 100 wt %, or 80 wt % to 99.5 wt %, or 85 wt % to 99 wt %, or 90 wt % to 97 wt %, or 4 to 90 wt %). In a preferred embodiment, the comonomer is present at 6 to 10 wt %, and is preferably a C₃ to C₁₂ alpha-olefin (preferably one or more of propylene, butene, hexene, and octene).

The comonomer can be one or more C₃ to C₂₀ olefin comonomer (preferably C₃ to C₁₂ alpha-olefin; more preferably propylene, butene, hexene, octene, decene, and/or dodecane; most preferably propylene, butene, hexene, and/or octene). Preferably, the monomer is ethylene and the comonomer is hexene, preferably from 1 mol % to 15 mol % hexene, or 1 mol % to 10 mol % hexene, or 5 mol % to 15 mol % hexene, or 7 mol % to 11 mol % hexene.

The polyethylene used in films of the present disclosure can have:

(A) a I₂ of 1.0 g/10 min or greater (or 1.5 g/10 min to 2.1 g/10 min, or 1.6 g/10 min to 2.0 g/10 min, or 1.7 g/10 min to 1.9 g/10 min);

(B) a density of 0.90 g/cm³ to 0.9 g/cm³ (0.91 g/cm³ to 0.93 g/cm³, or 0.912 g/cm³ to 0.927 g/cm³, or 0.915 g/cm³ to 0.925 g/cm³);

(C) a g′_{LCB} of greater than 0.8 (or from 0.81 to 0.95),

(D) a ratio of comonomer content at Mz-LS to comonomer content at Mw-LS (CCMz/CCMw) of greater than 1.0, or from 1.1 to 3.5, or from 1.3 to 3.0,

(E) a ratio of comonomer content at Mn-LS to comonomer content at Mw-LS (CCMn/CCMw) of greater than 1.0, or from 1.1 to 3.5, or from 1.3 to 3.0, and

(F) a ratio of the g′_{LCB} to the g′_{Zave} is greater than 1.0, or from 1.1 to 10.

The polyethylene used in films of the present disclosure can have:

(A) a 12 of 1.5 g/10 min to 2.1 g/10 min (or 1.6 g/10 min to 2.0 g/10 min, or 1.7 g/10 min to 1.9 g/10 min);

(B) a density of 0.91 g/cm³ to 0.93 g/cm³ (or 0.912 g/cm³ to 0.927 g/cm³, or 0.915 g/cm³ to 0.925 g/cm³);

(C) a g′_{LCB} of greater than 0.8 (or from 0.81 to 0.95),

(D) a ratio of comonomer content at Mz-LS to comonomer content at Mw-LS (CCMz/CCMw) of greater than 1.0, or from 1.1 to 3.5, or from 1.3 to 3.0,

(E) a ratio of comonomer content at Mn-LS to comonomer content at Mw-LS (CCMn/CCMw) of greater than 1.0, or from 1.1 to 3.5, or from 1.3 to 3.0, and

(F) a ratio of the g′_{LCB} to the g′_{Zave} is greater than 1.0, or from 1.1 to 10.

The polyethylene used in films of the present disclosure can have:

(A) a 12 of 1.0 g/10 min or greater (or 1.5 g/10 min to 2.1 g/10 min, or 1.6 g/10 min to 2.0 g/10 min, or 1.7 g/10 min to 1.9 g/10 min);

(B) a density of 0.90 g/cm³ to 0.9 g/cm³ (0.91 g/cm³ to 0.93 g/cm³, or 0.912 g/cm³ to 0.927 g/cm³, or 0.915 g/cm³ to 0.925 g/cm³);

(C) a g′_{LCB} of greater than 0.8 (or from 0.81 to 0.95),

(D) a ratio of comonomer content at Mz-LS to comonomer content at Mw-LS (CCMz/CCMw) of greater than 1.0, or from 1.1 to 3.5, or from 1.3 to 3.0,

(E) a ratio of comonomer content at Mn-LS to comonomer content at Mw-LS

(CCMn/CCMw) of greater than 1.0, or from 1.1 to 3.5, or from 1.3 to 3.0,

(F) a ratio of the g′_{LCB} to the g′_{Zave} is greater than 1.0, or from 1.1 to 10,

(G) a Mz-LS of 300,000 g/mol or greater (or 300,000 g/mol to 600,000 g/mol, or 375,000 g/mol to 525,000 g/mol), and

(H) a g′_{LCB} value of 0.8 to 0.9 (or 0.81 to 0.85, or 0.82 to 0.84, or 0.830 to 0.839).

The polyethylene used in films of the present disclosure can have:

(A) a 12 of 1.5 g/10 min to 2.1 g/10 min (or 1.6 g/10 min to 2.0 g/10 min, or 1.7 g/10 min to 1.9 g/10 min);

(B) a density of 0.91 g/cm³ to 0.93 g/cm³ (or 0.912 g/cm³ to 0.927 g/cm³, or 0.915 g/cm³ to 0.925 g/cm³);

(C) a g′_{LCB} of greater than 0.8 (or from 0.81 to 0.95),

(D) a ratio of comonomer content at Mz-LS to comonomer content at Mw-LS (CCMz/CCMw) of greater than 1.0, or from 1.1 to 3.5, or from 1.3 to 3.0,

(E) a ratio of comonomer content at Mn-LS to comonomer content at Mw-LS (CCMn/CCMw) of greater than 1.0, or from 1.1 to 3.5, or from 1.3 to 3.0,

(F) a ratio of the g′_{LCB} to the g′_{Zave} is greater than 1.0, or from 1.1 to 10,

(G) a Mz-LS of 300,000 g/mol or greater (or 300,000 g/mol to 600,000 g/mol, or 375,000 g/mol to 525,000 g/mol), and

(H) a g′_{LCB} value of 0.8 to 0.9 (or 0.81 to 0.85, or 0.82 to 0.84, or 0.830 to 0.839).

The polyethylene used in films of the present disclosure can have:

(A) a I₂ of 1.0 g/10 min or greater (or 1.5 g/10 min to 2.1 g/10 min, or 1.6 g/10 min to 2.0 g/10 min, or 1.7 g/10 min to 1.9 g/10 min);

(B) density of 0.90 g/cm³ to 0.9 g/cm³ (0.91 g/cm³ to 0.93 g/cm³, or 0.912 g/cm³ to 0.927 g/cm³, or 0.915 g/cm³ to 0.925 g/cm³);

(C) a g′_{LCB} of greater than 0.8 (or from 0.81 to 0.95),

(D) a ratio of comonomer content at Mz-LS to comonomer content at Mw-LS (CCMz/CCMw) of greater than 1.0, or from 1.1 to 3.5, or from 1.3 to 3.0,

(E) a ratio of comonomer content at Mn-LS to comonomer content at Mw-LS

(CCMn/CCMw) of greater than 1.0, or from 1.1 to 3.5, or from 1.3 to 3.0,

(F) a ratio of the g′_{LCB} to the g′_{Zave} is greater than 1.0, or from 1.1 to 10,

(G) a Mz-LS of 300,000 g/mol or greater (or 300,000 g/mol to 600,000 g/mol, or 375,000 g/mol to 525,000 g/mol),

(H) a g′_{LCB} value of 0.8 to 0.9 (or 0.81 to 0.85, or 0.82 to 0.84, or 0.830 to 0.839), and one or more of:

(I) a DST of 0.85 to 0.95 (or 0.86 to 0.90, or 0.87),

(J) a SHR of 3 or greater (or 3 to 8, or 3 to 5),

(K) a melting temperature of 122° C. or greater (or 122° C. to 127° C., or 123° C. to 125° C.),

(L) a crystallization temperature of 110° C. or greater (or 110° C. to 115° C., or 110° C. to 113° C.),

(M) a Mw of 100,000 g/mol to 150,000 g/mol (or 105,000 g/mol to 140,000 g/mol, or 110,000 g/mol to 130,000 g/mol), and

(N) a Mw/Mn of 1 to 10 (or 1 to 3, or 2 to 4, or 3 to 5, or 4 to 7, or 5 to 10).

The polyethylene used in films of the present disclosure can have:

(A) a I₂ of 1.5 g/10 min to 2.1 g/10 min (or 1.6 g/10 min to 2.0 g/10 min, or 1.7 g/10 min to 1.9 g/10 min);

(B) a density of 0.91 g/cm³ to 0.93 g/cm³ (or 0.912 g/cm³ to 0.927 g/cm³, or 0.915 g/cm³ to 0.925 g/cm³);

(C) a g′_{LCB} of greater than 0.8 (or from 0.81 to 0.95),

(D) a ratio of comonomer content at Mz-LS to comonomer content at Mw-LS (CCMz/CCMw) of greater than 1.0, or from 1.1 to 3.5, or from 1.3 to 3.0,

(E) a ratio of comonomer content at Mn-LS to comonomer content at Mw-LS (CCMn/CCMw) of greater than 1.0, or from 1.1 to 3.5, or from 1.3 to 3.0,

(F) a ratio of the g′_{LCB} to the g′_{Zave} is greater than 1.0, or from 1.1 to 10,

(G) a Mz-LS of 300,000 g/mol or greater (or 300,000 g/mol to 600,000 g/mol, or 375,000 g/mol to 525,000 g/mol),

(H) a g′_{LCB} value of 0.8 to 0.9 (or 0.81 to 0.85, or 0.82 to 0.84, or 0.830 to 0.839), and one or more of:
(I) a DST of 0.85 to 0.95 (or 0.86 to 0.90, or 0.87),
(J) a SHR of 3 or greater (or 3 to 8, or 3 to 5),
(K) a melting temperature of 122° C. or greater (or 122° C. to 127° C., or 123° C. to 125° C.),
(L) a crystallization temperature of 110° C. or greater (or 110° C. to 115° C., or 110° C. to 113° C.),
(M) a Mw of 100,000 g/mol to 150,000 g/mol (or 105,000 g/mol to 140,000 g/mol, or 110,000 g/mol to 130,000 g/mol), and
(N) a Mw/Mn of 1 to 10 (or 1 to 3, or 2 to 4, or 3 to 5, or 4 to 7, or 5 to 10).

Further, the polyethylene (including any of the foregoing) used in films of the present disclosure can have an Mz-LS/Mw-Ls of 2 or more, alternately 3 or more.

Further, the polyethylene (including any of the foregoing) used in films of the present disclosure can have an Mz-LS/Mn-LS of 6 or more, alternately 8 or more, alternately 10 or more.

### Blends

In another embodiment, the polyethylene composition produced herein is combined with one or more additional polymers in a blend prior to being formed into a film. As used herein, a “blend” may refer to a dry or extruder blend of two or more different polymers, and in-reactor blends, including blends arising from the use of multi or mixed catalyst systems in a single reactor zone, and blends that result from the use of one or more catalysts in one or more reactors under the same or different conditions (e.g., a blend resulting from in series reactors (the same or different) each running under different conditions and/or with different catalysts).

Useful additional polymers include other polyethylenes, isotactic polypropylene, highly isotactic polypropylene, syndiotactic polypropylene, random copolymer of propylene and ethylene, and/or butene, and/or hexene, polybutene, ethylene vinyl acetate, LDPE, LLDPE, HDPE, ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, EPDM, block copolymer, styrenic block copolymers, polyamides, polycarbonates, PET resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, and/or polyisobutylene.

### Films and Methods

The polyethylene prepared by the process described herein are preferably formed in to films, particularly oriented films, such as machine direction oriented films.

The present disclosure relates to oriented polyethylene films comprising a LLDPE with properties that improve processability while providing a good balance between stiffness while providing high toughness (or impact resistance).

For example, the invention relates to machine direction oriented films comprising polyethylene having:

(A) a I₂ of 1.0 g/10 min or greater (or 1.5 g/10 min to 2.1 g/10 min, or 1.6 g/10 min to 2.0 g/10 min, or 1.7 g/10 min to 1.9 g/10 min);

(B) a density of 0.90 g/cm³ to 0.9 g/cm³ (0.91 g/cm³ to 0.93 g/cm³, or 0.912 g/cm³ to 0.927 g/cm³, or 0.915 g/cm³ to 0.925 g/cm³);

(C) a g′_{LCB} of greater than 0.8 (or from 0.81 to 0.95),

(D) a ratio of comonomer content at Mz-LS to comonomer content at Mw-LS (CCMz/CCMw) of greater than 1.0, or from 1.1 to 3.5, or from 1.3 to 3.0,

(E) a ratio of comonomer content at Mn-LS to comonomer content at Mw-LS (CCMn/CCMw) of greater than 1.0, or from 1.1 to 3.5, or from 1.3 to 3.0, and

(F) a ratio of the g′_{LCB} to the g′_{Zave} is greater than 1.0, or from 1.1 to 10, and

wherein the film has a 1% secant in the transverse direction of 70,000 psi or more (alternately 75,000 psi to 150,000 psi, or 80,000 psi to 140,000 psi, or 90,000 psi to 130,000 psi) and Dart Drop of 350 g/mil or more (alternately 350 g/mil to 1300 g/mil, or 375 g/mil to 1250 g/mil, or 450 g/mil to 1225 g/mil).

In another example, the invention relates to machine direction oriented films comprising polyethylene having:

(A) a I₂ of 1.5 g/10 min to 2.1 g/10 min (or 1.6 g/10 min to 2.0 g/10 min, or 1.7 g/10 min to 1.9 g/10 min);

(B) a density of 0.91 g/cm³ to 0.93 g/cm³ (or 0.912 g/cm³ to 0.927 g/cm³, or 0.915 g/cm³ to 0.925 g/cm³);

(C) a g′_{LCB} of greater than 0.8 (or from 0.81 to 0.95),

(D) a ratio of comonomer content at Mz-LS to comonomer content at Mw-LS (CCMz/CCMw) of greater than 1.0, or from 1.1 to 3.5, or from 1.3 to 3.0,

(E) a ratio of comonomer content at Mn-LS to comonomer content at Mw-LS (CCMn/CCMw) of greater than 1.0, or from 1.1 to 3.5, or from 1.3 to 3.0, and

(F) a ratio of the g′_{LCB} to the g′_{Zave} is greater than 1.0, or from 1.1 to 10, and

wherein the film has a 1% secant in the transverse direction of 70,000 psi or more (alternately 75,000 psi to 150,000 psi, or 80,000 psi to 140,000 psi, or 90,000 psi to 130,000 psi) and Dart Drop per mil of 350 g/mil or more (alternately 350 g/mil to 1300 g/mil, or 375 g/mil to 1250 g/mil, or 450 g/mil to 1225 g/mil).

In embodiments the film has an Elmendorf Tear MD value of more than 400 g/mil, alternately more than 350 g/mil, alternately more than 400 g/mil, alternately from 300 to 600 g/mil.

The films of the present disclosure are uniaxially stretched in the machine direction (MD) and comprise the polyethylene described herein. Preferably, the films of the present disclosure comprise polyethylene in an amount of at least 90 wt % (or 90 wt % to 100 wt %, or 90 wt % to 99.9 wt %, or 95 wt % to 99 wt %). Advantageously, the polyethylene described herein does not need to be mixed with another polymer to achieve good processability and film properties.

In addition to the polyethylene, the films may comprise additives. Examples of additives include, but are not limited to, stabilization agents (e.g., antioxidants or other heat or light stabilizers), anti-static agents, crosslink agents or co-agents, crosslink promoters, release agents, adhesion promoters, plasticizers, anti-agglomeration agents (e.g., oleamide, stearamide, erucamide or other derivatives with the same activity), and fillers.

Nonlimiting examples of antioxidants include, but are not limited to, IRGANOX® 1076 (a high molecular weight phenolic antioxidant, available from BASF), IRGAFOS® 168 (tris(2,4-di-tert-butylphenyl) phosphite, available from BASF), and tris(nonylphenyl)phosphite. A nonlimiting example of a processing aid is DYNAMAR® FX-5920 (a free-flowingfluropolymer based processing additive, available from 3M).

When present, the amount of the additives cumulatively may range from 0.01 wt % to 1 wt % (or 0.01 wt % to 0.1 wt %, or 0.1 wt % to 1 wt %).

Methods of producing machine direction oriented (MDO) polyethylene films can comprise: producing a polymer melt comprising a polyethylene described herein, extruding a film from the polymer melt; and stretching the film at a temperature below the melting temperature of the polyethylene. Stretching can be achieved by threading the film through a series of rollers where the temperature and speed of the individual rollers are controlled to achieve a desired film thickness and the stretch ratio. Typically, this series of rollers are called MDO rollers or part of the MDO stage of the film production. Examples of MDO may include, but are not limited to, pre-heat rollers, various stretching stages with or without annealing rollers between stages, one or more conditioning and annealing rollers, and one or more chill rollers. Stretching of the film in the MDO stage is accomplished by inducing a speed differential between two or more adjacent rollers.

The stretch ratio can be used to describe the degree of stretching of the film. The stretch ratio is the speed of the fast roller divided by the speed of the slow roller. For example, stretching a film using an apparatus where the slow roller speed is 1 m/min and fast roller speed is 7 m/min means the stretch ratio was 7 (also referred to herein as 7 times or 7×). The physical amount of stretching of the film is close to but not exactly the stretch ratio because relaxation of the film can occur after stretching, although typically only to a marginal extent.

Greater stretch ratios result in thinner films with greater orientation in the MD. The stretch ratio when stretching the polyethylene films described herein can be 1× to 10× (or 3× to 10×, or 5× to 10×, or 7× to 9×). One skilled in the art without undo experimentation can determine suitable temperatures and roller speeds for each roller in a given MDO stage of film production for producing the desired stretch ratios.

The MDO polyethylene films described herein can have a thickness of 5 mils to 30 mils (or 15 mils or less, or 10 mils or less, or 8 mils or less, or 7 mils or less, or 5 mils to 10 mils, or 5 mils to 15 mils, or 10 mils to 30 mils).

The MDO polyethylene films described herein have (I) a 1% secant in the transverse direction of 70,000 psi or more (alternately 75,000 psi to 150,000 psi, or 80,000 psi to 140,000 psi, or 90,000 psi to 130,000 psi) and (II) Dart Drop per mil of 350 g/mil or more (alternately 350 g/mil to 1300 g/mil, or 375 g/mil to 1250 g/mil, or 450 g/mil to 1225 g/mil).

The MDO polyethylene films described herein can also have one or more of the following properties:

(III) a 1% secant in the machine direction of 30,000 psi to 110,000 psi (or 40,000 psi to 1,000,000 psi, or 50,000 psi to 1,000,000 psi, or 60,000 psi to 1,000,000 psi, or 70,000 psi to 1,000,000 psi, or 80,000 psi to 1,000,000 psi);

(IV) a yield strength in the machine direction of 500 psi to 10,000 psi (or 2,000 psi to 10,000 psi, or 4,000 psi to 10,000 psi);

(V) an elongation at yield in the machine direction of 5% to 15% (or 7% to 14%, or 9% to 13%);

(VI) a tensile strength in the machine direction of 5,500 psi to 25,000 psi (or 7,000 psi to 23,000 psi, or 10,000 psi to 22,000 psi);

(VII) a tensile strength per mil in the machine direction of 250 psi/mil to 4,000 psi/mil (or 500 psi/mil to 3,500 psi/mil, or 1,500 psi/mil to 3,300 psi/mil, or 1,750 psi/mil to 3,200 psi/mil);

(VIII) an elongation at break in the machine direction of 60% to 450% (or 100% to 400%, or 150% to 350%);

(IX) an Elmendorf tear in the machine direction of 40 g to 1,500 g (or 200 g to 1,500 g, or 500 g to 1,500 g, or 1,000 g to 1,500 g);

(X) an Elmendorf tear per mil in the machine direction of 5 g/mil to 150 g/mil (or 10 g/mil to 150 g/mil, or 50 g/mil to 150 g/mil, or 100 g/mil to 150 g/mil); and

(XI) a shrink in the machine direction of 60% to 90% (or 70% to 90%, or 80% to 90%).

Preferably, the MDO polyethylene films described herein has (I) and (II) and one or more of the following properties: (III), (IV), (V), (VI), (VII), (VIII), (IX), and (X). More preferably, the MDO polyethylene films described herein has one or more of the following properties: (IV), (V), (VI), and (VII).

Because the films described herein are stretched only in the machine direction, the physical properties in the transverse direction may be comparable to other MDO polyethylene films produced with polyethylenes not described herein. The MDO polyethylene films described herein can also have one or more of the following properties:

(XI) a yield strength in the transverse direction of 1,000 psi to 1,500 psi (or 1,100 psi to 1,400 psi);

(XII) an elongation at yield in the transverse direction of 5% to 10% (or 7% to 10%);

(XIII) a tensile strength in the transverse direction of 200 psi to 3,000 psi (or 2,250 psi to 2,800 psi);

(XIV) a tensile strength per mil in the transverse direction of 50 psi/mil to 500 psi/mil (or 100 psi/mil to 400 psi/mil);

(XV) an elongation at break in the transverse direction of 300% to 1,200% (or 500% to 1,200%, or 600% to 1,200%);

(XVI) an Elmendorf tear in the transverse direction 1,500 g to 6,000 g (or 2,000 g to 5,000 g);

(XVII) an Elmendorf tear per mil in the transverse direction of 200 g to 700 g (or 300 g to 600 g); and

(XVIII) a shrink in the transverse direction of 10% to 40% (or 15% to 30%).

Preferably, the MDO polyethylene films described herein has one or more of the following properties: (X), (XI), (XII), (XIII), (XIV), and (XV). More preferably, the MDO polyethylene films described herein has one or more of the following properties: (XIII) and (XIV).

### End Uses

The MDO polyethylene films described herein may be used as monolayer films or as one or more layers of a multilayer film. Examples of other layers include, but are not limited to, unstretched polymer films, other MDO polymer films, and biaxially-oriented polymer films of polymers like polyethylene, polypropylene, polyethylene terephthalate, polystyrene, polyamide, and the like.

Specific end use films include, for example, blown films, cast films, stretch films, stretch/cast films, stretch cling films, stretch handwrap films, machine stretch wrap, shrink films, shrink wrap films, green house films, laminates, and laminate films. Exemplary films are prepared by any conventional technique known to those skilled in the art, such as for example, techniques utilized to prepare blown, extruded, and/or cast stretch and/or shrink films (including shrink-on-shrink applications).

The MDO polyethylene films described herein (alone or as part of a multilayer film) are useful end use applications that include, but are not limited to, film-based products, shrink film, cling film, stretch film, sealing films, snack packaging, heavy-duty bags, grocery sacks, baked and frozen food packaging, diaper backsheets, housewrap, medical packaging (e.g., medical films and intravenous (IV) bags), industrial liners, membranes, and the like.

In one embodiment, multilayer films or multiple-layer films may be formed by methods well known in the art. The total thickness of multilayer films may vary based upon the application desired. A total film thickness of about 5-100 μm, more typically about 10-50 μm, is suitable for most applications. Those skilled in the art will appreciate that the thickness of individual layers for multilayer films may be adjusted based on desired end-use performance, resin or copolymer employed, equipment capability, and other factors. The materials forming each layer may be coextruded through a coextrusion feedblock and die assembly to yield a film with two or more layers adhered together but differing in composition. Coextrusion can be adapted for use in both cast film or blown film processes. Exemplary multilayer films have at least two, at least three, or at least four layers. In one embodiment, the multilayer films are composed of five to ten layers.

To facilitate discussion of different film structures, the following notation is used herein. Each layer of a film is denoted “A” or B. Where a film includes more than one A layer or more than one B layer, one or more prime symbols (′, “, ‘”, etc.) are appended to the A or B symbol to indicate layers of the same type that can be the same or can differ in one or more properties, such as chemical composition, density, melt index, thickness, etc. Finally, the symbols for adjacent layers are separated by a slash (/). Using this notation, a three-layer film having an inner layer disposed between two outer layers would be denoted A/B/A′. Similarly, a five-layer film of alternating layers would be denoted A/B/A′/B′/A″. Unless otherwise indicated, the left-to-right or right-to-left order of layers does not matter, nor does the order of prime symbols; e.g., an A/B film is equivalent to a B/A film, and an A/A′/B/A″ film is equivalent to an A/B/A′/A″ film, for purposes described herein. The relative thickness of each film layer is similarly denoted, with the thickness of each layer relative to a total film thickness of 100 (dimensionless) indicated numerically and separated by slashes; e.g., the relative thickness of an A/B/A′ film having A and A′ layers of 10 μm each and a B layer of 30 μm is denoted as 20/60/20.

The thickness of each layer of the film, and of the overall film, is not particularly limited, but is determined according to the desired properties of the film. Typical film layers have a thickness of from about 1 to about 1,000 μm, more typically from about 5 to about 100 μm, and typical films have an overall thickness of from about 10 to about 100 μm.

In some embodiments, and using the nomenclature described above, the present invention provides for multilayer films with any of the following exemplary structures: (a) two-layer films, such as A/B and B/B′; (b) three-layer films, such as A/B/A′, A/A′/B, B/A/B′ and B/B′/B″; (c) four-layer films, such as A/A′/A″/B, A/A′/B/A″, A/A′/B/B′, A/B/A′/B′, A/B/B′/A′, B/A/A′/B′, A/B/B′/B″, B/A/B′/B″ and B/B′/B″/B′″; (d) five-layer films, such as A/A′/A″/A′″/B, A/A′/A″/B/A′″, A/A′/B/A″/A′″, A/A′/A″/B/B′, A/A′/B/A″/B′, A/A′/B/B′/A″, A/B/A′/B′/A″, A/B/A′/A″/B, B/A/A′/A″/B′, A/A′/B/B′/B″, A/B/A′/B′/B″, A/B/B′/B″/A′, B/A/A′/B′/B″, B/A/B′/A′/B″, B/A/B′/B″/A′, A/B/B′/B″/B′″, B/A/B′/B″/B′″, B/B′/A/B″/B′ ″, and B/B′/B″/B′″/B″″; and similar structures for films having six, seven, eight, nine, twenty-four, forty-eight, sixty-four, one hundred, or any other number of layers. It should be appreciated that films having still more layers.

In any of the embodiments above, one or more A layers can be replaced with a substrate layer, such as glass, plastic, paper, metal, etc., or the entire film can be coated or laminated onto a substrate. Thus, although the discussion herein has focused on multilayer films, the films may also be used as coatings for substrates such as paper, metal, glass, plastic, and other materials capable of accepting a coating.

The films can further be embossed, or produced or processed according to other known film processes. The films can be tailored to specific applications by adjusting the thickness, materials and order of the various layers, as well as the additives in or modifiers applied to each layer.

### Example Embodiments

A first non-limiting example embodiment is a composition comprising: a machine direction oriented film comprising a polyethylene having:

(A) a I₂ of 1.0 g/10 min or greater (or 1.5 g/10 min to 2.1 g/10 min, or 1.6 g/10 min to 2.0 g/10 min, or 1.7 g/10 min to 1.9 g/10 min);

(B) a density of 0.90 g/cm³ to 0.9 g/cm³ (0.91 g/cm³ to 0.93 g/cm³, or 0.912 g/cm³ to 0.927 g/cm³, or 0.915 g/cm³ to 0.925 g/cm³);

(C) a g′_{LCB} of greater than 0.8 (or from 0.81 to 0.95),

(D) a ratio of comonomer content at Mz-LS to comonomer content at Mw-LS

(CCMz/CCMw) of greater than 1.0, or from 1.1 to 3.5, or from 1.3 to 3.0,

(E) a ratio of comonomer content at Mn-LS to comonomer content at Mw-LS (CCMn/CCMw) of greater than 1.0, or from 1.1 to 3.5, or from 1.3 to 3.0, and

(F) a ratio of the g′_{LCB} to the g′_{Zave} is greater than 1.0, or from 1.1 to 10, and

wherein the film has (I) a 1% secant in the transverse direction of 70,000 psi or more (alternately 75,000 psi to 150,000 psi, or 80,000 psi to 140,000 psi, or 90,000 psi to 130,000 psi) and (II) Dart Drop per mil of 350 g/mil or more (alternately 350 g/mil to 1,300 g/mil, or 375 g/mil to 1,250 g/mil, or 450 g/mil to 1,225 g/mil).

The first non-limiting example embodiment can further include one or more of the following: Element 1: wherein the polyethylene also has one or more of the following: (G) a Mz-LS of 300,000 g/mol or greater (or 300,000 g/mol to 600,000 g/mol, or 375,000 g/mol to 525,000 g/mol), (H) a g′_{LCB} value of 0.8 to 0.9 (or 0.81 to 0.85, or 0.82 to 0.84, or 0.830 to 0.839), (I) a DST of 0.85 to 0.95 (or 0.86 to 0.90, or 0.87), (J) a SHR of 3 or greater (or 3 to 8, or 3 to 5), (K) a melting temperature of 122° C. or greater (or 122° C. to 127° C., or 123° C. to 125° C.), (L) a crystallization temperature of 110° C. or greater (or 110° C. to 115° C., or 110° C. to 113° C.), (M) a Mw of 100,000 g/mol to 150,000 g/mol (or 105,000 g/mol to 140,000 g/mol, or 110,000 g/mol to 130,000 g/mol), and (N) a Mw/Mn of 1 to 10 (or 1 to 3, or 2 to 4, or 3 to 5, or 4 to 7, or 5 to 10); Element 2: wherein the polyethylene is present at 90 wt % to 100 wt % of the film; Element 3: wherein the machine direction oriented film further comprises an additive at 0.01 wt % to 1 wt % of film; Element 4: wherein the film has a thickness of 5 mils to 30 mils (or 15 mils or less, or 10 mils or less, or 8 mils or less, or 7 mils or less, or 5 mils to 10 mils, or 5 mils to 15 mils, or 10 mils to 30 mils); Element 5: wherein the film has one or more of the following properties: (III) a 1% secant in the machine direction of 30,000 psi to 110,000 psi (or 40,000 psi to 1,000,000 psi, or 50,000 psi to 1,000,000 psi, or 60,000 psi to 1,000,000 psi, or 70,000 psi to 1,000,000 psi, or 80,000 psi to 1,000,000 psi); (IV) a yield strength in the machine direction of 500 psi to 10,000 psi (or 2,000 psi to 10,000 psi, or 4,000 psi to 10,000 psi); (V) an elongation at yield in the machine direction of 5% to 15% (or 7% to 14%, or 9% to 13%); (VI) a tensile strength in the machine direction of 5,500 psi to 25,000 psi (or 7,000 psi to 23,000 psi, or 10,000 psi to 22,000 psi); (VII) a tensile strength per mil in the machine direction of 250 psi/mil to 4,000 psi/mil (or 500 psi/mil to 3,500 psi/mil, or 1,500 psi/mil to 3,300 psi/mil, or 1,750 psi/mil to 3,200 psi/mil); (VIII) an elongation at break in the machine direction of 60% to 450% (or 100% to 400%, or 150% to 350%); (IX) an Elmendorf tear in the machine direction of 40 g to 1,500 g (or 200 g to 1,500 g, or 500 g to 1,500 g, or 1,000 g to 1,500 g); (X) an Elmendorf tear per mil in the machine direction of 5 g/mil to 150 g/mil (or 10 g/mil to 150 g/mil, or 50 g/mil to 150 g/mil, or 100 g/mil to 150 g/mil); and (XI) a shrink in the machine direction of 60% to 90% (or 70% to 90%, or 80% to 90%); and Element 6: Element 5 and wherein the film also has one or more of the following properties: (XII) a yield strength in the transverse direction of 1,000 psi to 1,500 psi (or 1,100 psi to 1,400 psi); (XIII) an elongation at yield in the transverse direction of 5% to 10% (or 7% to 10%); (XIV) a tensile strength in the transverse direction of 200 psi to 3,000 psi (or 2,250 psi to 2,800 psi); (XV) a tensile strength per mil in the transverse direction of 50 psi/mil to 500 psi/mil (or 100 psi/mil to 400 psi/mil); (XVI) an elongation at break in the transverse direction of 300% to 1,200% (or 500% to 1,200%, or 600% to 1,200%); (XVII) an Elmendorf tear in the transverse direction 1500 g to 6,000 g (or 2,000 g to 5,000 g); (XVIII) an Elmendorf tear per mil in the transverse direction of 200 g to 700 g (or 300 g to 600 g); and (XIX) a shrink in the transverse direction of 10% to 40% (or 15% to 30%). Examples of combinations include, but are not limited to, two or more of Elements 1-3 in combination (where when Elements 2 and 3 are in combination the polyethylene is present at 90 wt % to 99.9 wt % of the film); Elements 4 and 5 in combination and optionally in further combination with Element 6; and one or more of Elements 1-3 in combination with one or more of Elements 4-6.

A second non-limiting example embodiment is a method comprising: producing a polymer melt comprising a polyethylene having: (A) a I₂ of 1.0 g/10 min or greater (or 1.5 g/10 min to 2.1 g/10 min, or 1.6 g/10 min to 2.0 g/10 min, or 1.7 g/10 min to 1.9 g/10 min); (B) a density of 0.90 g/cm³ to 0.9 g/cm³ (0.91 g/cm³ to 0.93 g/cm³, or 0.912 g/cm³ to 0.927 g/cm³, or 0.915 g/cm³ to 0.925 g/cm³); (C) a g′_{LCB} of greater than 0.8 (or from 0.81 to 0.95), (D) a ratio of comonomer content at Mz-LS to comonomer content at Mw-LS (CCMz/CCMw) of greater than 1.0, or from 1.1 to 3.5, or from 1.3 to 3.0, (E) a ratio of comonomer content at Mn-LS to comonomer content at Mw-LS (CCMn/CCMw) of greater than 1.0, or from 1.1 to 3.5, or from 1.3 to 3.0, and (F) a ratio of the g′_{LCB} to the g′_{Zave} is greater than 1.0, or from 1.1 to 10; extruding a film from the polymer melt; and stretching the film in a machine direction at a temperature below the melting temperature of the polyethylene. The second non-limiting example embodiment can further include one or more of the following: Element 1; Element 2; Element 3; Element 4; Element 5; Element 6; and Element 7: wherein stretching is at a stretch ratio of 1 to 10. Examples of combinations include, but are not limited to, two or more of Elements 1-3 in combination (where when Elements 2 and 3 are in combination the polyethylene is present at 90 wt % to 99.9 wt % of the film); Elements 4 and 5 in combination and optionally in further combination with Element 6; one or more of Elements 1-3 in combination with one or more of Elements 4-6; and Element 7 in combination with one or more of Elements 1-6.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

The invention relates to machine direction oriented films comprising polyethylene having:

(A) a I₂ of 1.0 g/10 min or greater (or 1.5 g/10 min to 2.1 g/10 min, or 1.6 g/10 min to 2.0 g/10 min, or 1.7 g/10 min to 1.9 g/10 min);

(B) a density of 0.90 g/cm³ to 0.9 g/cm³ (0.91 g/cm³ to 0.93 g/cm³, or 0.912 g/cm³ to 0.927 g/cm³, or 0.915 g/cm³ to 0.925 g/cm³);

(C) a g′_{LCB} of greater than 0.8 (or from 0.81 to 0.95),

(D) a ratio of comonomer content at Mz-LS to comonomer content at Mw-LS (CCMz/CCMw) of greater than 1.0, or from 1.1 to 3.5, or from 1.3 to 3.0,

(E) a ratio of comonomer content at Mn-LS to comonomer content at Mw-LS (CCMn/CCMw) of greater than 1.0, or from 1.1 to 3.5, or from 1.3 to 3.0, and

(F) a ratio of the g′_{LCB} to the g′_{Zave} is greater than 1.0, or from 1.1 to 10, and

wherein the film has a 1% secant in the transverse direction of 70,000 psi or more (alternately 75,000 psi to 150,000 psi, or 80,000 psi to 140,000 psi, or 90,000 psi to 130,000 psi) and Dart Drop of 350 g/mil or more (alternately 350 g/mil to 1,300 g/mil, or 375 g/mil to 1,250 g/mil, or 450 g/mil to 1,225 g/mil).

The invention also relates to machine direction oriented films comprising polyethylene having:

(A) a I₂ of 1.5 g/10 min to 2.1 g/10 min (or 1.6 g/10 min to 2.0 g/10 min, or 1.7 g/10 min to 1.9 g/10 min);

(B) a density of 0.91 g/cm³ to 0.93 g/cm³ (or 0.912 g/cm³ to 0.927 g/cm³, or 0.915 g/cm³ to 0.925 g/cm³);

(C) a g′_{LCB} of greater than 0.8 (or from 0.81 to 0.95),

(D) a ratio of comonomer content at Mz-LS to comonomer content at Mw-LS (CCMz/CCMw) of greater than 1.0, or from 1.1 to 3.5, or from 1.3 to 3.0,

(E) a ratio of comonomer content at Mn-LS to comonomer content at Mw-LS (CCMn/CCMw) of greater than 1.0, or from 1.1 to 3.5, or from 1.3 to 3.0, and

(F) a ratio of the g′_{LCB} to the g′_{Zave} is greater than 1.0, or from 1.1 to 10, and

wherein the film has a 1% secant in the transverse direction of 70,000 psi or more (alternately 75,000 psi to 150,000 psi, or 80,000 psi to 140,000 psi, or 90,000 psi to 130,000 psi) and Dart Drop per mil of 350 g/mil or more (alternately 350 g/mil to 1,300 g/mil, or 375 g/mil to 1,250 g/mil, or 450 g/mil to 1,225 g/mil).

This invention relates to compositions comprising:

1) a machine direction oriented film comprising a polyethylene present at 90 wt % to 100 wt % (or 90 wt % to 100 wt %, or 90 wt % to 99.9 wt %, or 95 wt % to 99 wt %) of the film and an additive at 0 wt % to 1 wt % (or 0.01 wt % to 0.1 wt %, or 0.1 wt % to 1 wt %) of the film;

2) wherein the polyethylene has:
(A) a I₂ of 1.5 g/10 min to 2.1 g/10 min (or 1.6 g/10 min to 2.0 g/10 min, or 1.7 g/10 min to 1.9 g/10 min);
(B) a density of 0.91 g/cm³ to 0.93 g/cm³ (or 0.912 g/cm³ to 0.927 g/cm³, or 0.915 g/cm³ to 0.925 g/cm³);
(C) a g′_{LCB} of greater than 0.8 (or from 0.81 to 0.95),
(D) a ratio of comonomer content at Mz-LS to comonomer content at Mw-LS (CCMz/CCMw) of greater than 1.0, or from 1.1 to 3.5, or from 1.3 to 3.0,
(E) a ratio of comonomer content at Mn-LS to comonomer content at Mw-LS (CCMn/CCMw) of greater than 1.0, or from 1.1 to 3.5, or from 1.3 to 3.0,
(F) a ratio of the g′_{LCB} to the g′_{Zave} is greater than 1.0, or from 1.1 to 10,
(G) a Mz-LS of 300,000 g/mol or greater (or 300,000 g/mol to 600,000 g/mol, or 375,000 g/mol to 525,000 g/mol),
(H) a g′_{LCB} value of 0.8 to 0.9 (or 0.81 to 0.85, or 0.82 to 0.84, or 0.830 to 0.839), and one or more of:
   (I) a DST of 0.85 to 0.95 (or 0.86 to 0.90, or 0.87),
   (J) a SHR of 3 or greater (or 3 to 8, or 3 to 5),
   (K) a melting temperature of 122° C. or greater (or 122° C. to 127° C., or 123° C. to 125° C.),
   (L) a crystallization temperature of 110° C. or greater (or 110° C. to 115° C., or 110° C. to 113° C.),
   (M) a Mw of 100,000 g/mol to 150,000 g/mol (or 105,000 g/mol to 140,000 g/mol, or 110,000 g/mol to 130,000 g/mol), and
   (N) a Mw/Mn of 1 to 10 (or 1 to 3, or 2 to 4, or 3 to 5, or 4 to 7, or 5 to 10); and

3) wherein the film has a thickness of 5 mils to 30 mils (or 15 mils or less, or 10 mils or less, or 8 mils or less, or 7 mils or less, or 5 mils to 10 mils, or 5 mils to 15 mils, or 10 mils to 30 mils); and

4) wherein the machine direction oriented film has (I) and (II) properties and optionally one or more of (III)-(XIX) properties:
(I) a 1% secant in the transverse direction of 70,000 psi or more (alternately 75,000 psi to 150,000 psi, or 80,000 psi to 140,000 psi, or 90,000 psi to 130,000 psi),
(II) Dart Drop per mil of 350 g/mil or more (alternately 350 g/mil to 1,300 g/mil, or 375 g/mil to 1,250 g/mil, or 450 g/mil to 1,225 g/mil),
(III) a 1% secant in the machine direction of 30,000 psi to 110,000 psi (or 40,000 psi to 1,000,000 psi, or 50,000 psi to 1,000,000 psi, or 60,000 psi to 1,000,000 psi, or 70,000 psi to 1,000,000 psi, or 80,000 psi to 1,000,000 psi);
(IV) a yield strength in the machine direction of 500 psi to 10,000 psi (or 2,000 psi to 10,000 psi, or 4,000 psi to 10,000 psi);
(V) an elongation at yield in the machine direction of 5% to 15% (or 7% to 14%, or 9% to 13%);
(VI) a tensile strength in the machine direction of 5,500 psi to 25,000 psi (or 7,000 psi to 23,000 psi, or 10,000 psi to 22,000 psi);
(VII) a tensile strength per mil in the machine direction of 250 psi/mil to 4,000 psi/mil (or 500 psi/mil to 3,500 psi/mil, or 1,500 psi/mil to 3,300 psi/mil, or 1,750 psi/mil to 3,200 psi/mil);
(VIII) an elongation at break in the machine direction of 60% to 450% (or 100% to 400%, or 150% to 350%);
(IX) an Elmendorf tear in the machine direction of 40 g to 1,500 g (or 200 g to 1,500 g, or 500 g to 1,500 g, or 1,000 g to 1,500 g);
(X) an Elmendorf tear per mil in the machine direction of 5 g/mil to 150 g/mil (or 10 g/mil to 150 g/mil, or 50 g/mil to 150 g/mil, or 100 g/mil to 150 g/mil);
(XI) a shrink in the machine direction of 60% to 90% (or 70% to 90%, or 80% to 90%),
(XII) a yield strength in the transverse direction of 1,000 psi to 1,500 psi (or 1,100 psi to 1,400 psi);
(XIII) an elongation at yield in the transverse direction of 5% to 10% (or 7% to 10%);
(XIV) a tensile strength in the transverse direction of 200 psi to 3,000 psi (or 2,250 psi to 2,800 psi);
(XV) a tensile strength per mil in the transverse direction of 50 psi/mil to 500 psi/mil (or 100 psi/mil to 400 psi/mil);
(XVI) an elongation at break in the transverse direction of 300% to 1,200% (or 500% to 1,200%, or 600% to 1,200%);
(XVII) an Elmendorf tear in the transverse direction 1,500 g to 6,000 g (or 2,000 g to 5,000 g);
(XVIII) an Elmendorf tear per mil in the transverse direction of 200 g to 700 g (or 300 g to 600 g); and
(XIX) a shrink in the transverse direction of 10% to 40% (or 15% to 30%).

This invention also relates to methods of making said compositions, the methods comprising:

1) producing a polymer melt comprising a polyethylene having (A)-(E) properties and optionally one or more of (F)-(K) properties:
(A) a I₂ of 1.5 g/10 min to 2.1 g/10 min (or 1.6 g/10 min to 2.0 g/10 min, or 1.7 g/10 min to 1.9 g/10 min);
(B) a density of 0.91 g/cm³ to 0.93 g/cm³ (or 0.912 g/cm³ to 0.927 g/cm³, or 0.915 g/cm³ to 0.925 g/cm³);
(C) a g′_{LCB} of greater than 0.8 (or from 0.81 to 0.95),
(D) a ratio of comonomer content at Mz-LS to comonomer content at Mw-LS (CCMz/CCMw) of greater than 1.0, or from 1.1 to 3.5, or from 1.3 to 3.0,
(E) a ratio of comonomer content at Mn-LS to comonomer content at Mw-LS (CCMn/CCMw) of greater than 1.0, or from 1.1 to 3.5, or from 1.3 to 3.0,
(F) a ratio of the g′_{LCB} to the g′_{Zave} is greater than 1.0, or from 1.1 to 10,
(G) a Mz-LS of 300,000 g/mol or greater (or 300,000 g/mol to 600,000 g/mol, or 375,000 g/mol to 525,000 g/mol),
(H) a g′_{LCB} value of 0.8 to 0.9 (or 0.81 to 0.85, or 0.82 to 0.84, or 0.830 to 0.839), and

one or more of:
(I) a DST of 0.85 to 0.95 (or 0.86 to 0.90, or 0.87),
(J) a SHR of 3 or greater (or 3 to 8, or 3 to 5),
(K) a melting temperature of 122° C. or greater (or 122° C. to 127° C., or 123° C. to 125° C.),
(L) a crystallization temperature of 110° C. or greater (or 110° C. to 115° C., or 110° C. to 113° C.),
(M) a Mw of 100,000 g/mol to 150,000 g/mol (or 105,000 g/mol to 140,000 g/mol, or 110,000 g/mol to 130,000 g/mol), and
(N) a Mw/Mn of 1 to 10 (or 1 to 3, or 2 to 4, or 3 to 5, or 4 to 7, or 5 to 10); and

2) extruding a film from the polymer melt; and

3) stretching the film in a machine direction (e.g., at a stretch ratio of 1 to 10) at a temperature below the melting temperature of the polyethylene to form a machine direction oriented film (e.g., having a thickness of 5 mils to 30 mils (or 15 mils or less, or 10 mils or less, or 8 mils or less, or 7 mils or less, or 5 mils to 10 mils, or 5 mils to 15 mils, or 10 mils to 30 mils)), wherein the film has (I) and (II) properties and optionally one or more of (III)-(XIX) properties:
(I) a 1% secant in the transverse direction of 70,000 psi or more (alternately 75,000 psi to 150,000 psi, or 80,000 psi to 140,000 psi, or 90,000 psi to 130,000 psi),
(II) Dart Drop per mil of 350 g/mil or more (alternately 350 g/mil to 1,300 g/mil, or 375 g/mil to 1,250 g/mil, or 450 g/mil to 1,225 g/mil),
(III) a 1% secant in the machine direction of 30,000 psi to 110,000 psi (or 40,000 psi to 1,000,000 psi, or 50,000 psi to 1,000,000 psi, or 60,000 psi to 1,000,000 psi, or 70,000 psi to 1,000,000 psi, or 80,000 psi to 1,000,000 psi);
(IV) a yield strength in the machine direction of 500 psi to 10,000 psi (or 2,000 psi to 10,000 psi, or 4,000 psi to 10,000 psi);
(V) an elongation at yield in the machine direction of 5% to 15% (or 7% to 14%, or 9% to 13%);
(VI) a tensile strength in the machine direction of 5,500 psi to 25,000 psi (or 7,000 psi to 23,000 psi, or 10,000 psi to 22,000 psi);
(VII) a tensile strength per mil in the machine direction of 250 psi/mil to 4,000 psi/mil (or 500 psi/mil to 3,500 psi/mil, or 1,500 psi/mil to 3,300 psi/mil, or 1,750 psi/mil to 3,200 psi/mil);
(VIII) an elongation at break in the machine direction of 60% to 450% (or 100% to 400%, or 150% to 350%);
(IX) an Elmendorf tear in the machine direction of 40 g to 1,500 g (or 200 g to 1,500 g, or 500 g to 1,500 g, or 1,000 g to 1,500 g);
(X) an Elmendorf tear per mil in the machine direction of 5 g/mil to 150 g/mil (or 10 g/mil to 150 g/mil, or 50 g/mil to 150 g/mil, or 100 g/mil to 150 g/mil);
(XI) a shrink in the machine direction of 60% to 90% (or 70% to 90%, or 80% to 90%),
(XII) a yield strength in the transverse direction of 1,000 psi to 1,500 psi (or 1,100 psi to 1,400 psi);
(XIII) an elongation at yield in the transverse direction of 5% to 10% (or 7% to 10%);
(XIV) a tensile strength in the transverse direction of 200 psi to 3,000 psi (or 2,250 psi to 2,800 psi);
(XV) a tensile strength per mil in the transverse direction of 50 psi/mil to 500 psi/mil (or 100 psi/mil to 400 psi/mil);
(XVI) an elongation at break in the transverse direction of 300% to 1,200% (or 500% to 1,200%, or 600% to 1,200%);
(XVII) an Elmendorf tear in the transverse direction 1,500 g to 6,000 g (or 2,000 g to 5,000 g);
(XVIII) an Elmendorf tear per mil in the transverse direction of 200 g to 700 g (or 300 g to 600 g); and
(XIX) a shrink in the transverse direction of 10% to 40% (or 15% to 30%).

The invention also relates to Embodiment A1, which is a composition comprising: a machine direction oriented film comprising a polyethylene having: (A) a I₂ of 1.0 g/10 min or greater (or 1.5 g/10 min to 2.1 g/10 min, or 1.6 g/10 min to 2.0 g/10 min, or 1.7 g/10 min to 1.9 g/10 min); (B) a density of 0.90 g/cm³ to 0.9 g/cm³ (0.91 g/cm³ to 0.93 g/cm³, or 0.912 g/cm³ to 0.927 g/cm³, or 0.915 g/cm³ to 0.925 g/cm³); (C) a g′_{LCB} of greater than 0.8 (or from 0.81 to 0.95), (D) a ratio of comonomer content at Mz-LS to comonomer content at Mw-LS (CCMz/CCMw) of greater than 1.0, or from 1.1 to 3.5, or from 1.3 to 3.0, (E) a ratio of comonomer content at Mn-LS to comonomer content at Mw-LS (CCMn/CCMw) of greater than 1.0, or from 1.1 to 3.5, or from 1.3 to 3.0, and (F) a ratio of the g′_{LCB} to the g′_{Zave} is greater than 1.0, or from 1.1 to 10.

The invention also relates to Embodiment A2, which is the composition of Embodiment A1, wherein the polyethylene also has one or more of the following: (G) a Mz-LS of 300,000 g/mol or greater (or 300,000 g/mol to 600,000 g/mol, or 375,000 g/mol to 525,000 g/mol), (H) a g′_{LCB} value of 0.8 to 0.9 (or 0.81 to 0.85, or 0.82 to 0.84, or 0.830 to 0.839), (I) a DST of 0.85 to 0.95 (or 0.86 to 0.90, or 0.87), (J) a SHR of 3 or greater (or 3 to 8, or 3 to 5), (K) a melting temperature of 122° C. or greater (or 122° C. to 127° C., or 123° C. to 125° C.), (L) a crystallization temperature of 110° C. or greater (or 110° C. to 115° C., or 110° C. to 113° C.), (M) a Mw of 100,000 g/mol to 150,000 g/mol (or 105,000 g/mol to 140,000 g/mol, or 110,000 g/mol to 130,000 g/mol), and (N) a Mw/Mn of 1 to 10 (or 1 to 3, or 2 to 4, or 3 to 5, or 4 to 7, or 5 to 10).

The invention also relates to Embodiment A3, which is the composition of Embodiment A1 or A2, wherein the polyethylene is present at 90 wt % to 100 wt % of the film.

The invention also relates to Embodiment A4, which is the composition of Embodiment A1 or A2 or A3, wherein the machine direction oriented film further comprises an additive at 0.01 wt % to 1 wt % of film (where when Embodiments A3 and A4 are in combination the polyethylene is present at 90 wt % to 99.9 wt % of the film).

The invention also relates to Embodiment A5, which is the composition of Embodiment A1 or A2 or A3 or A4, wherein the film has a thickness of 15 mils or less.

The invention also relates to Embodiment A6, which is the composition of Embodiment A1 or A2 or A3 or A4 or A5, wherein the film has a thickness of 10 mils or less.

The invention also relates to Embodiment A7, which is the composition of Embodiment A1 or A2 or A3 or A4 or A5 or A6, wherein the film has a thickness of 7 mils or less.

The invention also relates to Embodiment A7, which is the composition of Embodiment A1 or A2 or A3 or A4 or A5 or A6 or A7, wherein the film has one or more of the following properties: (III) a 1% secant in the machine direction of 30,000 psi to 110,000 psi (or 40,000 psi to 1,000,000 psi, or 50,000 psi to 1,000,000 psi, or 60,000 psi to 1,000,000 psi, or 70,000 psi to 1,000,000 psi, or 80,000 psi to 1,000,000 psi); (IV) a yield strength in the machine direction of 500 psi to 10,000 psi (or 2,000 psi to 10,000 psi, or 4,000 psi to 10,000 psi); (V) an elongation at yield in the machine direction of 5% to 15% (or 7% to 14%, or 9% to 13%); (VI) a tensile strength in the machine direction of 5,500 psi to 25,000 psi (or 7,000 psi to 23,000 psi, or 10,000 psi to 22,000 psi); (VII) a tensile strength per mil in the machine direction of 250 psi/mil to 4,000 psi/mil (or 500 psi/mil to 3,500 psi/mil, or 1,500 psi/mil to 3,300 psi/mil, or 1,750 psi/mil to 3,200 psi/mil); (VIII) an elongation at break in the machine direction of 60% to 450% (or 100% to 400%, or 150% to 350%); (IX) an Elmendorf tear in the machine direction of 40 g to 1,500 g (or 200 g to 1,500 g, or 500 g to 1,500 g, or 1,000 g to 1,500 g); (X) an Elmendorf tear per mil in the machine direction of 5 g/mil to 150 g/mil (or 10 g/mil to 150 g/mil, or 50 g/mil to 150 g/mil, or 100 g/mil to 150 g/mil); and (XI) a shrink in the machine direction of 60% to 90% (or 70% to 90%, or 80% to 90%).

The invention also relates to Embodiment A7, which is the composition of Embodiment A8, wherein the film also has one or more of the following properties: (XII) a yield strength in the transverse direction of 1,000 psi to 1,500 psi (or 1,100 psi to 1,400 psi); (XIII) an elongation at yield in the transverse direction of 5% to 10% (or 7% to 10%); (XIV) a tensile strength in the transverse direction of 200 psi to 3,000 psi (or 2,250 psi to 2,800 psi); (XV) a tensile strength per mil in the transverse direction of 50 psi/mil to 500 psi/mil (or 100 psi/mil to 400 psi/mil); (XVI) an elongation at break in the transverse direction of 300% to 1,200% (or 500% to 1,200%, or 600% to 1,200%); (XVII) an Elmendorf tear in the transverse direction 1,500 g to 6,000 g (or 2,000 g to 5,000 g); (XVIII) an Elmendorf tear per mil in the transverse direction of 200 g to 700 g (or 300 g to 600 g); and (XIX) a shrink in the transverse direction of 10% to 40% (or 15% to 30%).

The invention also relates to Embodiment B1, which is a method comprising: producing a polymer melt comprising a polyethylene having: (A) a 12 of 1.0 g/10 min or greater (or 1.5 g/10 min to 2.1 g/10 min, or 1.6 g/10 min to 2.0 g/10 min, or 1.7 g/10 min to 1.9 g/10 min); (B) a density of 0.90 g/cm³ to 0.9 g/cm³ (0.91 g/cm³ to 0.93 g/cm³, or 0.912 g/cm³ to 0.927 g/cm³, or 0.915 g/cm³ to 0.925 g/cm³); (C) a g′_{LCB} of greater than 0.8 (or from 0.81 to 0.95), (D) a ratio of comonomer content at Mz-LS to comonomer content at Mw-LS (CCMz/CCMw) of greater than 1.0, or from 1.1 to 3.5, or from 1.3 to 3.0, (E) a ratio of comonomer content at Mn-LS to comonomer content at Mw-LS (CCMn/CCMw) of greater than 1.0, or from 1.1 to 3.5, or from 1.3 to 3.0, and (F) a ratio of the g′_{LCB} to the g′_{Zave} is greater than 1.0, or from 1.1 to 10; extruding a film from the polymer melt; and stretching the film in a machine direction at a temperature below the melting temperature of the polyethylene.

The invention also relates to Embodiment B2, which is the method of Embodiment B1, wherein stretching is at a stretch ratio of 1 to 10.

The invention also relates to Embodiment B3, which is the composition of Embodiment B1 or B2, wherein the polyethylene also has one or more of the following: (G) a Mz-LS of 300,000 g/mol or greater (or 300,000 g/mol to 600,000 g/mol, or 375,000 g/mol to 525,000 g/mol), (H) a g′_{LCB} value of 0.8 to 0.9 (or 0.81 to 0.85, or 0.82 to 0.84, or 0.830 to 0.839), (I) a DST of 0.85 to 0.95 (or 0.86 to 0.90, or 0.87), (J) a SHR of 3 or greater (or 3 to 8, or 3 to 5), (K) a melting temperature of 122° C. or greater (or 122° C. to 127° C., or 123° C. to 125° C.), (L) a crystallization temperature of 110° C. or greater (or 110° C. to 115° C., or 110° C. to 113° C.), (M) a Mw of 100,000 g/mol to 150,000 g/mol (or 105,000 g/mol to 140,000 g/mol, or 110,000 g/mol to 130,000 g/mol), and (N) a Mw/Mn of 1 to 10 (or 1 to 3, or 2 to 4, or 3 to 5, or 4 to 7, or 5 to 10).

The invention also relates to Embodiment B4, which is the composition of Embodiment B1 or B2 or B3, wherein the polyethylene is present at 90 wt % to 100 wt % of the film.

The invention also relates to Embodiment B5, which is the composition of Embodiment B1 or B2 or B3 or B4, wherein the machine direction oriented film further comprises an additive at 0.01 wt % to 1 wt % of film (where when Embodiments B4 and B5 are in combination the polyethylene is present at 90 wt % to 99.9 wt % of the film).

The invention also relates to Embodiment B6, which is the composition of Embodiment B1 or B2 or B3 or B4 or B5, wherein the film has a thickness of 15 mils or less.

The invention also relates to Embodiment B7, which is the composition of Embodiment B1 or B2 or B3 or B4 or B5 or B6, wherein the film has a thickness of 10 mils or less.

The invention also relates to Embodiment B8, which is the composition of Embodiment B1 or B2 or B3 or B4 or B5 or B6 or B7, wherein the film has a thickness of 7 mils or less.

The invention also relates to Embodiment B9, which is the composition of Embodiment B1 or B2 or B3 or B4 or B5 or B6 or B7 or B8, wherein the film has one or more of the following properties: (III) a 1% secant in the machine direction of 30,000 psi to 110,000 psi (or 40,000 psi to 1,000,000 psi, or 50,000 psi to 1,000,000 psi, or 60,000 psi to 1,000,000 psi, or 70,000 psi to 1,000,000 psi, or 80,000 psi to 1,000,000 psi); (IV) a yield strength in the machine direction of 500 psi to 10,000 psi (or 2,000 psi to 10,000 psi, or 4,000 psi to 10,000 psi); (V) an elongation at yield in the machine direction of 5% to 15% (or 7% to 14%, or 9% to 13%); (VI) a tensile strength in the machine direction of 5,500 psi to 25,000 psi (or 7,000 psi to 23,000 psi, or 10,000 psi to 22,000 psi); (VII) a tensile strength per mil in the machine direction of 250 psi/mil to 4,000 psi/mil (or 500 psi/mil to 3,500 psi/mil, or 1,500 psi/mil to 3,300 psi/mil, or 1,750 psi/mil to 3,200 psi/mil); (VIII) an elongation at break in the machine direction of 60% to 450% (or 100% to 400%, or 150% to 350%); (IX) an Elmendorf tear in the machine direction of 40 g to 1,500 g (or 200 g to 1,500 g, or 500 g to 1,500 g, or 1,000 g to 1,500 g); (X) an Elmendorf tear per mil in the machine direction of 5 g/mil to 150 g/mil (or 10 g/mil to 150 g/mil, or 50 g/mil to 150 g/mil, or 100 g/mil to 150 g/mil); and (XI) a shrink in the machine direction of 60% to 90% (or 70% to 90%, or 80% to 90%).

The invention also relates to Embodiment B10, which is the composition of Embodiment B9, wherein the film also has one or more of the following properties: (XII) a yield strength in the transverse direction of 1,000 psi to 1,500 psi (or 1,100 psi to 1,400 psi); (XIII) an elongation at yield in the transverse direction of 5% to 10% (or 7% to 10%); (XIV) a tensile strength in the transverse direction of 200 psi to 3,000 psi (or 2,250 psi to 2,800 psi); (XV) a tensile strength per mil in the transverse direction of 50 psi/mil to 500 psi/mil (or 100 psi/mil to 400 psi/mil); (XVI) an elongation at break in the transverse direction of 300% to 1,200% (or 500% to 1,200%, or 600% to 1,200%); (XVII) an Elmendorf tear in the transverse direction 1,500 g to 6,000 g (or 2,000 g to 5,000 g); (XVIII) an Elmendorf tear per mil in the transverse direction of 200 g to 700 g (or 300 g to 600 g); and (XIX) a shrink in the transverse direction of 10% to 40% (or 15% to 30%).

The invention also relates to Embodiment B1, which is a method comprising: producing a polymer melt comprising a polyethylene having: (A) a 12 of 1.0 g/10 min or greater (or 1.5 g/10 min to 2.1 g/10 min, or 1.6 g/10 min to 2.0 g/10 min, or 1.7 g/10 min to 1.9 g/10 min); (B) a density of 0.90 g/cm³ to 0.9 g/cm³ (0.91 g/cm³ to 0.93 g/cm³, or 0.912 g/cm³ to 0.927 g/cm³, or 0.915 g/cm³ to 0.925 g/cm³); (C) a g′_{LCB} of greater than 0.8 (or from 0.81 to 0.95), (D) a ratio of comonomer content at Mz-LS to comonomer content at Mw-LS (CCMz/CCMw) of greater than 1.0, or from 1.1 to 3.5, or from 1.3 to 3.0, (E) a ratio of comonomer content at Mn-LS to comonomer content at Mw-LS (CCMn/CCMw) of greater than 1.0, or from 1.1 to 3.5, or from 1.3 to 3.0, and (F) a ratio of the g′_{LCB} to the g′_{Zave} is greater than 1.0, or from 1.1 to 10; extruding a film from the polymer melt; and stretching the film in a machine direction at a temperature below the melting temperature of the polyethylene.

To facilitate a better understanding of the embodiments of the present invention, the following examples of preferred or representative embodiments are given. In no way should the following examples be read to limit, or to define, the scope of the invention.

### Examples

Me₂Si[Me₄Cp][3-Ph-Ind]ZrCl₂, dimethylsilyl (tetramethylcyclopentadienyl)(3-phenylindenyl)zirconium dichloride was prepared as generally described in U.S. Pat. No. 9,266,977 (see Metallocene 1).

Preparation of Me₂Si[Me₄Cp][3-Ph-Ind]ZrCl₂ Supported Catalyst

Activation and supportation of Me₂Si[Me₄Cp][3-Ph-Ind]ZrCl₂ was prepared as follows. In a 4L stirred vessel in the drybox a 687 g amount of methylaluminoxane (MAO) (30 wt % in toluene) was added along with a 1504 g amount of toluene. A 15.7 g amount of the metallocene dissolved in 200 mL of toluene was added. This solution was then stirred at 60 rpm for 5 minutes. Another 165 g amount of toluene was added. The solution was stirred for 30 minutes at 120 rpm. The stir rate was reduced to 8 rpm. ES-70™ silica (PQ Corporation, Conshohocken, Pa.) that had been calcined at 875° C. was added to the vessel. This slurry with another 154 grams of toluene for rinse was stirred for 30 minutes before drying under vacuum at room temperature for twenty-two hours. After emptying the vessel and sieving the supported catalyst, a 763 gram amount was collected.

### Gas Phase Polymerization

The polymerizations were run employing the Me₂Si[Me₄Cp][3-Ph-Ind]ZrCl₂ supported catalyst (Polymerizations 1 and 2 see Table A). Each polymerization was performed in an 18.5 ft tall gas-phase fluidized bed reactor with a 10 ft body and an 8.5 ft expanded section. Cycle and feed gases were fed into the reactor body through a perforated distributor plate, and the reactor was controlled at 300 psi and 70 mol % ethylene. The reactor temperature was maintained at 185° F. (85° C.) throughout each of the polymerizations by controlling the temperature of the cycle gas loop. Each catalyst was delivered in a mineral oil slurry containing 20 wt % supported catalyst. Specific information relevant to each polymerization is provided in Table 1.

TABLE 1

| Polymerization | 1 | 2 |
|---|---|---|
| Polymer product | I-1 | I-2 |
| H₂ conc. (mol ppm) | 85 | 65 |
| C₆/C₂ ration (mol %/mol %) | 5.14 | 4.48 |
| Comonomer conc. (mol %) | 1.88 | 2.31 |
| C₂ conc. (mol %) | 70 | 70.9 |
| Comonomer/C₂ flow ratio | 0.110 | 0.145 |
| H₂/C₂ ratio (ppm/mol %) | 1.2 | 0.9 |
| Reaction pressure SP (psig) | 300 | 300 |
| Reactor temp. (° F.) | 185 | 180 |
| Avg. bedweight (lb) | 356 | 356 |
| Production (lb/hr) | 42 | 47 |
| Residence time (hr) | 8.5 | 7.6 |
| Avg. velocity (ft/s) | 2.25 | 1.95 |
| Catalyst slurry feed (cc/hr) | 17.2 | 13.4 |
| Catalyst slurry conc. (wt frac.) | 0.2 | 0.2 |
| Catalyst feed (g/hr) | 3.248 | 2.521 |
| Catalyst activity (g poly/g cat) | 5860 | 8465 |

Example 1. Ethylene 1-hexene copolymer samples with properties reported in Table 2 were used in preparing polyethylene films. The C-1 is a comparative sample, and I-1 and 1-2 are inventive samples. C-1 is a metallocene ethylene 1-hexene copolymer LLDPE. C-1, I-1 and I-2 granules were pelletized using a 57 mm Werner-Pfleiderer compounder with 300 ppm IRGANOX™ 1076, 1500 ppm IRGAFOS™ 168, and 400 ppm DYNAMAR™ FX-5929 (a free-flowing fluropolymer based processing additive, available from 3M).

TABLE 2

| Property | C-1 | I-1 | I-2 |
|---|---|---|---|
| I₂ (g/10 min) | 0.95 | 1.7 | 1.9 |
| Density (g/cm³) | 0.921 | 0.923 | 0.918 |
| Tₘ (° C.) | 114 | 125 | 123 |
| T_{c} (° C.) | 103 | 112 | 111 |
| degree of shear thinning | 0.93 | 0.87 | 0.88 |
| (DST) | | | |
| Strain Hardening Ratio (SHR) | 1.6 | 4.5 | 3.6 |
| M_{w} (g/mol) (LS) | 103,000 | 126,000 | 120,000 |
| M_{z} (g/mol) (LS) | 202,000 | 490,000 | 402,000 |
| Mₙ (g/mol) (LS) | 31,000 | 29,000 | 30,000 |
| Comonomer content (wt %) | 7.0 | 8.0 | 10.2 |
| g′_{LCB} | 0.934 | 0.832 | 0.837 |
| g′_{LCB}/g′_{Mz} | 1 | 1.3 | 1.2 |
| wt % comonomer at Mz/wt % | 1 | 1.3 | 1.1 |
| wt % comnomer at Mw | | | |
| wt % comonomer at Mn/wt % | 1 | 1.5 | 1.5 |
| wt % comonomer at Mw | | | |

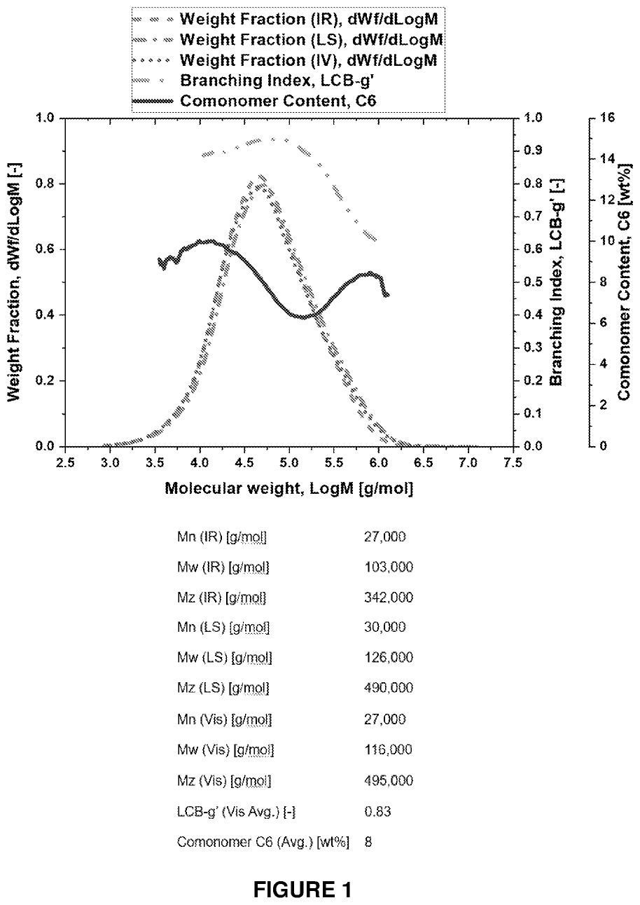

FIG. 1 (FIG. 1) is a GPC-4D print out of example I-1 with a table of various characteristics of said printout.

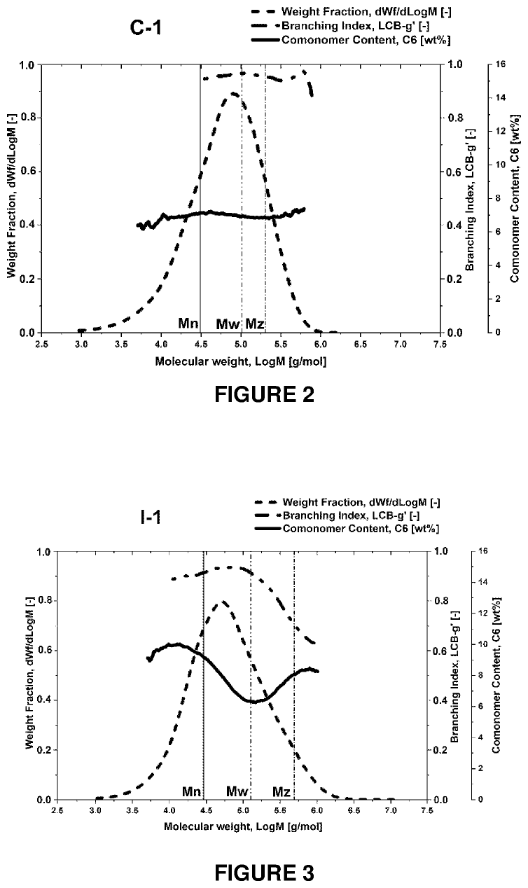

FIG. 2 (FIG. 2) is a graph of the weight fraction versus molecular weight (LS), comonomer content (wt %) versus molecular weight and branching index versus molecular weight for Example C-1.

FIG. 3 (FIG. 3) is a graph of the weight fraction versus molecular weight (LS), comonomer content (wt %) versus molecular weight and branching index versus molecular weight for Example I-1.

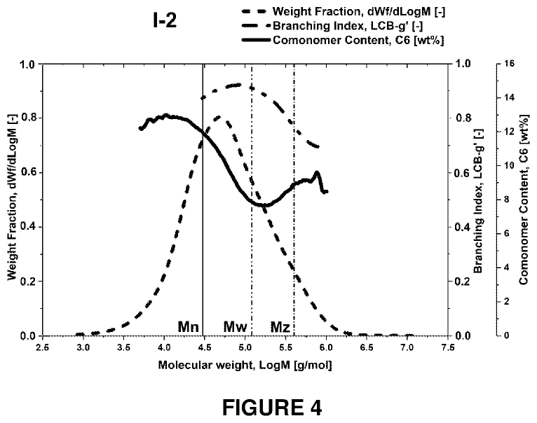

FIG. 4 (FIG. 4) is a graph of the weight fraction versus molecular weight (LS), comonomer content (wt %) versus molecular weight and branching index versus molecular weight for Example 1-2.

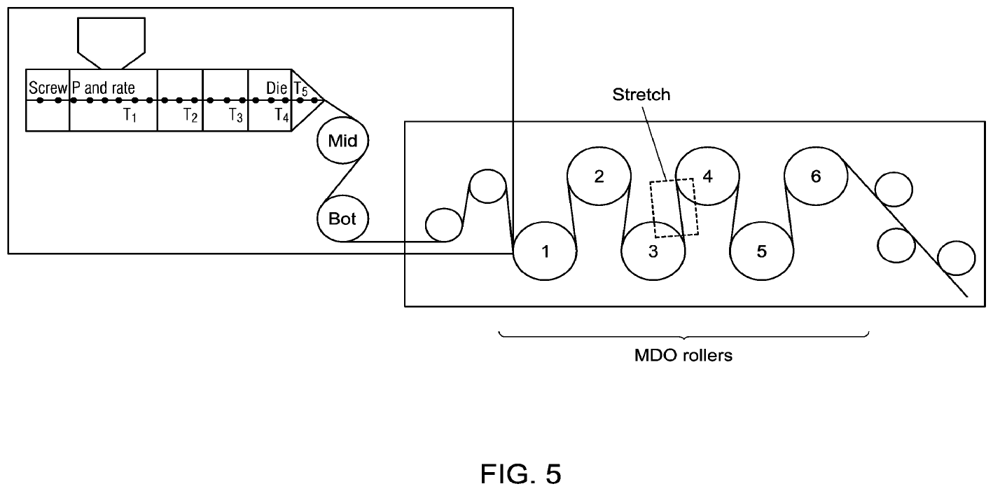

The polyethylene films were fabricated by using a Cincinnati Milacron S-PAK 150. The equipment is designed to support the reducer, barrel, and control cabinet. The extrusion section was mounted on the floor and stabilized with a set of mobile and fixed casters. The motor has the capability to 10 HP and the gear reducer is rated for 24 HP at 100 rpm. A single layer extrusion cast line with a 12-inch die was used to obtain monolayer films. FIG. 5 (FIG. 5) is a diagram of the extruder and rollers used to make the MDO polyethylene films of the present examples. This illustrates the five temperature zones of the extruder including the temperature at the die (Zone 5). The extruder temperature profile was set according to Table 4 and monitored. The single screw pressure and rate were controlled to ensure optimal processing conditions. The processing conditions of the extrusion section are reported in Table 5.

TABLE 4

| | Zone 1 | Zone 2 | Zone 3 | Zone 4 | Zone 5 |
|---|---|---|---|---|---|
| Sample | (° C.) | (° C.) | (° C.) | (° C.) | (° C.) |
| C-1 | 180 | 230 | 219 | 203 | 225 |
| I-1 | 185 | 235 | 224 | 208 | 230 |
| I-2 | 185 | 235 | 224 | 208 | 230 |

TABLE 5

| | | | | | | Melt |
|---|---|---|---|---|---|---|
| | Inlet | Melt | Outlet | Extruder | Gear | temper- |
| | pressure | pressure | pressure | rate | pump rate | ature |
| Sample | (psi) | (psi) | (psi) | (rpm) | (rpm) | (° C.) |
| C-1 | 2700 | 4000 | 2000 | 85 | 35 | 232 |
| I-1 | 2500 | 4000 | 2000 | 83 | 35 | 248 |
| I-2 | 2300 | 360 | 1850 | 92 | 35 | 216 |

The pelletized samples were fed in the extruder where it was applied an accurate temperature, pressure, and rate control. The molten material was spread on two rolls (mid roll: T=90° C., rotation rate=1 m/min and bot roll T=90° C., rotation rate=1m/min) and then guided to the MDO rollers, see FIG. 5. The extruder and roll stack section were needed in order to have a homogeneous gauge and width before reaching the MDO section. The temperature profile was well-controlled at the roll/film interface due to an internal oil circulation but not at the air/film interface where the film was exposed at the environment (room temperature). This temperature gradient may generate some shear orientation on the pre-oriented film.

The stretch ratio were controlled by rotation speed and temperature of the rollers, see Table 6. The bulk of the stretching in the MD occurs between rollers 3 and 4.

TABLE 6

| | C-1 | | I-1 | | I-2 | |
|---|---|---|---|---|---|---|
| | Temp | Speed | Temp | Speed | Temp | Speed |
| Roller | (° C.) | (m/min) | (° C.) | (m/min) | (° C.) | (m/min) |
| 1 | 100 | 1 | 100 | 1 | 100 | 1 |
| 2 | 100 | 1 | 100 | 1 | 100 | 1 |
| 3 | 110 | 1 | 115 | 1 | 115 | 1 |
| 4 | 100 | 3, 5, 7 | 105 | 3, 5, 7 | 105 | 3, 5, |
| | | | | | | 7, 8 |
| 5 | 70 | 3, 5, 7 | 70 | 3, 5, 7 | 70 | 3, 5, |
| | | | | | | 7, 8 |
| 6 | 25 | 3, 5, 7 | 25 | 3, 5, 7 | 25 | 3, 5, |
| | | | | | | 7, 8 |

Three stretch ratio (3×, 5× and 7×) were aimed for the 4 samples. Unfortunately, C-1 could not be stretched at ratio higher than 5×. Above 5×, periodic transversal streaks were observed on the films due to stickiness and slippage issues on the slow and fast roll, respectively. Although some adjustments could be done for example with the roll speed and temperature, in general, the two materials were not performing equally well as I-1 and I-2. Sometimes the transversal streaks or inhomogeneities in the cast films can be solved by increasing the stretch ratio.

On the other hand, I-1 and I-2 were easily stretched at higher deformations (7× and 8×, respectively) and also processed at higher temperatures.

The MDO polyethylene films after production were conditioned for 40 hours at 23° C.±2° C. and 50%±10% relative humidity per ASTM D618−08.

Table 7 provides the properties of the MDO polyethylene films. Relative to strain hardening, for all samples, the tensile stress growth exhibit deviations from LVE for extension rate between 0.1 s⁻¹ and 10 s⁻¹ at 150° C. In the nonlinear regime, branching and high molecular weight polymers present strain-hardening profiles in extensional viscosity testing.

TABLE 7

| MDO | | | | | | | | | |
|---|---|---|---|---|---|---|---|---|---|
| Polyethylene Film | | | | | | | | | |
| Property | 3x C-1 | 5x C-1 | 3x I-1 | 5x I-1 | 7x I-1 | 3x I-2 | 5x I-2 | 7x I-2 | 8x I-2 |
| Gauge (mil) MD | 22.8 | 11.1 | 21.9 | 12.4 | 8.0 | 18.7 | 10.7 | 7.5 | 6.6 |
| 1% secant modulus | 37000 | 67000 | 40000 | 60000 | 99000 | 33000 | 50000 | 76000 | 98000 |
| (psi) MD | | | | | | | | | |
| Yield strength (psi) | 5300 | 12000 | 2800 | 1200 | 1300 | 4300 | 9300 | 740 | 550 |
| MD | | | | | | | | | |
| Elongation at yield | 7.9 | 7.8 | 9.9 | 9.6 | 10.3 | 9.1 | 7.8 | 11.5 | 10.4 |
| (%) MD | | | | | | | | | |
| Tensile strength | 9800 | 17000 | 6500 | 11000 | 19000 | 5900 | 9600 | 15000 | 20000 |
| (psi) MD | | | | | | | | | |
| Tensile strength | 420 | 1500 | 300 | 890 | 2400 | 320 | 590 | 2000 | 3000 |
| per mil (psi/mil) | | | | | | | | | |
| MD | | | | | | | | | |
| Elongation at break | 207 | 62 | 341 | 137 | 103 | 245 | 100 | 91 | 71 |
| (%) MD | | | | | | | | | |
| Elmendorf tear (g) | 1400 | 410 | 1300 | 450 | 80 | 1400 | 1300 | 60 | 40 |
| MD | | | | | | | | | |
| Elmendorf tear per | 62 | 37 | 60 | 37 | 10 | 76 | 121 | 8 | 6 |
| mil (g/mil) MD | | | | | | | | | |
| Shrink (%) MD | 72 | 82 | 68 | 81 | 86 | 68 | 79 | 85 | 85 |
| 1% secant modulus | 52000 | 93000 | 53000 | 79000 | 96000 | 43000 | 57000 | 70000 | 75000 |
| (psi) TD | | | | | | | | | |
| Yield strength (psi) | 1190 | 1340 | 1300 | 1360 | 1280 | 1310 | 1190 | 1180 | 1270 |
| TD | | | | | | | | | |
| Elongation at yield | 9.1 | 7.5 | 7.3 | 7 | 7.4 | 9 | 6.8 | 7.7 | 6.9 |
| (%) TD | | | | | | | | | |
| Tensile strength | 2800 | 3100 | 2300 | 2700 | 2800 | 2500 | 2600 | 2500 | 2500 |
| (psi) TD | | | | | | | | | |
| Tensile strength | 120 | 280 | 100 | 220 | 360 | 130 | 250 | 340 | 380 |
| per mil (psi/mil) | | | | | | | | | |
| TD | | | | | | | | | |
| Elongation at break | 1100 | 800 | 850 | 330 | 340 | 910 | 1030 | 1050 | 1080 |
| (%) TD | | | | | | | | | |
| Elmendorf tear (g) | — | — | — | — | 4450 | — | — | 3360 | 2150 |
| TD | | | | | | | | | |
| Elmendorf tear per | — | — | — | — | 560 | — | — | 450 | 330 |
| mil (g/mil) TD | | | | | | | | | |
| Shrink (%) TD | 40 | 17 | 19 | 19 | 19 | 16 | 18 | 25 | 28 |
| Haze (%) | 30 | 7.4 | 30 | 20.8 | 9.6 | 30 | 30 | 18.8 | 20.1 |
| Transparency (%) | 21.4 | 80.2 | 1 | 19.7 | 48.7 | 1.4 | 27.6 | 44.5 | 54.5 |
| Gloss (gloss units) | 2 | 9.1 | 1.9 | 4.8 | 9.2 | 1.3 | 3.7 | 7.1 | 9.2 |
| Puncture peak | — | — | — | — | 8.4 | — | — | 12.2 | 14.4 |
| force per mil | | | | | | | | | |
| (lbs/mil) | | | | | | | | | |
| Puncture break | — | — | — | — | 3.6 | — | — | 15.4 | 18.1 |
| energy per mil | | | | | | | | | |
| (in*lbs/mil) | | | | | | | | | |
| Dart Drop (g) | — | — | — | — | 446 | — | — | 608 | 548 |
| Dart Drop per mil | — | — | — | — | 56.0 | — | — | 81.0 | 83.3 |
| (g/mil) | | | | | | | | | |
| WVTR | 0.6 | 1.4 | 0.7 | 1.1 | 2.0 | 0.9 | 1.6 | 2.6 | 3.1 |
| transmission | | | | | | | | | |
| average | | | | | | | | | |
| (g/(m²*day)) | | | | | | | | | |
| WVTR permeation | 11.6 | 14.1 | 12.9 | 12.2 | 15.0 | 14.8 | 15.7 | 19.0 | 19.0 |
| average | | | | | | | | | |
| ((g*mil)/(m²*day)) | | | | | | | | | |

As illustrated in Table 7, the polyethylenes described herein can be stretched and down-gauged to smaller thicknesses with properties superior (e.g., 7× I-1 8.0 mil with 19,000 psi tensile strength and 8× I-2 at 6.6 mil with 20,000 psi tensile strength as compared to thicker films produced with polyethylenes (e.g., 5× C-1 with 17,000 psi tensile strength).

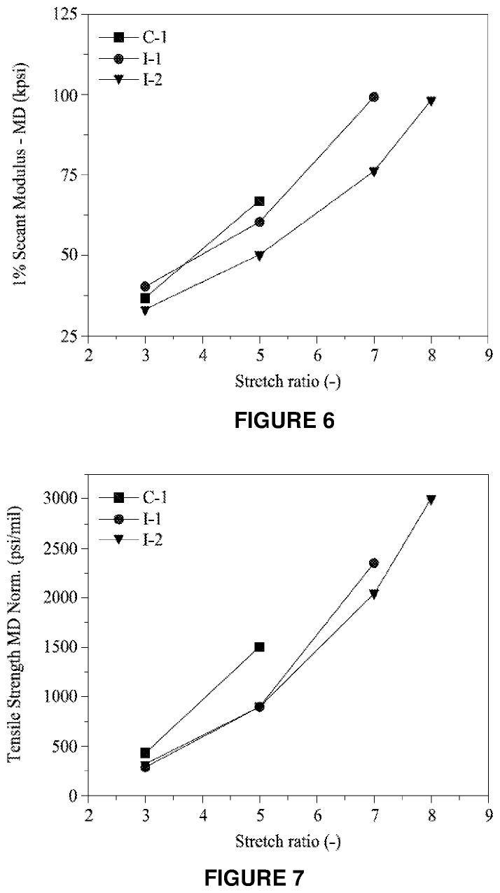

FIGS. 6 and 7 further illustrate the superior properties of films produced with the polyethylenes described herein. FIG. 6 (FIG. 6) is a plot of the 1% secant modulus in the machine direction as a function of the stretch ratio. FIG. 7 (FIG. 7) is a blot of the tensile strength per mil in the machine direction as a function of the stretch ratio.

Both the modulus and tensile strength per mil along MD for 8× I-1, which has the largest deformation, is greater than said properties for less stretched samples.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of” values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure.

The invention claimed is:

1. An oriented polyethylene film comprising polyethylene having:
(A) a melt flow index of 1.0 g/10 min or more,
(B) a density of 0.90 g/cm³ to less than 0.940 g/cm³,
(C) a g′_{LCB} of greater than 0.8,
(D) ratio of comonomer content at Mz to comonomer content at Mw greater than 1.0,
(E) ratio of comonomer content at Mn to comonomer content at Mw greater than 1.0, and
(F) a ratio of g′_{LCB} to g′_{Zave} greater than 1.0,
where the film has a 1% secant in the transverse direction of 70,000 psi or more and Dart Drop of 350 g/mil or more.

2. The film of claim 1, wherein the polyethylene has:
(A′) a melt flow index of 1.5 g/1.0 min to 2.1 g/10 min,
(B′) a density of 0.91 g/cm³ to 0.93 g/cm³,
(G) a z-average molecular weight of 300,000 g/mol or greater, and
(H) a long chain branching (g′_{LCB}) value of 0.8 to 0.9.

3. The film of claim 1, wherein the polyethylene also has one or more of the following:
(I) a degree of shear thinning of 0.85 to 0.95,
(J) a strain hardening ratio of 3 or greater,
(K) a melting temperature of 122° C. or greater,
(L) a crystallization temperature of 110° C. or greater,
(M) a Mw of 100,000 g/mol to 150,000 g/mol, and
(N) a Mw/Mn of 1 to 10.

4. The film of claim 1, wherein the polyethylene is present at 90 wt % to 100 wt iii of the film.

5. The film of any of claim 1, wherein the machine direction oriented film further comprises an additive at 0.01 wt % to 1 wt % of film.

6. The film of claim 1, wherein the film has a thickness of 15 mils or less.

7. The film of claim 1, wherein the film has a thickness of 10 mils or less.

8. The film of claim 1, wherein the film has a thickness of 7 mils or less.

9. The film of claim 1, wherein the polyethylene has a ratio of the g′_{LCB} to the g′_{Zave}, from 1.1 to 10.

10. The film of claim 1, wherein the film further has one or more of the following properties:
(III) a 1% secant in the machine direction of 30,000 psi to 110,000 psi;
(IV) a yield strength in the machine direction of 500 psi to 10,000 psi;
(V) an elongation at yield in the machine direction of 5% to 15%;
(VI) a tensile strength in the machine direction of 5,500 psi to 25,000 psi;
(VII) a tensile strength per mil in the machine direction of 250 psi/mil to 4,000 psi/mil;
(VIII) an elongation at break in the machine direction of 60% to 450%;
(IX) an Elmendorf tear in the machine direction of 40 g to 1,500 g;
(X) an Elmendorf tear per mil in the machine direction of 5 g/mil to 150 g/mil; and
(XI) a shrink in the machine direction of 60% to 90%.

11. The film of claim 10; wherein the film further has one or more of the following properties:
(XII) a yield strength in the transverse direction of 1,000 psi to 1,500 psi;
(XIII) an elongation at yield in the transverse direction of 5% to 10%;
(XIV) a tensile strength in the transverse direction of 200 psi to 3,000 psi;
(XV) a tensile strength per mil in the transverse direction of 50 psi/mil to 500 psi/mil;
(XVI) an elongation at break in the transverse direction of 300% to 1,200%;
(XVII) an Elmendorf tear in the transverse direction 1,500 g to 6,000 g;
(XVIII) an Elmendorf tear per mil in the transverse direction of 200 g to 700 g; and
(XIX) a shrink in the transverse direction of 10% to 40%.

12. A method comprising:
producing a polymer melt comprising a polyethylene having:
(A) a melt flow index of 1.0 g/10 min or more,
(B) a density of 0.90 g/cm³ to less than 0.940 g/cm³
(C) a g′_{LCB} of greater than 0.8,
(D) ratio of comonomer content at Mz to comonomer content at Mw greater than 1.0;
(E) ratio of comonomer content at Mn to comonomer content at Mw greater than 1.0, and
(F) a ratio of g′_{LCB} to g′_{Zave} greater than 1.0;
extruding a film from the polymer melt; and
stretching the film in a machine direction at a temperature below the melting temperature of the polyethylene, where the film has a 1% secant in the transverse direction of 70,000 psi or more and Dart Drop of 350 g/mil or more.

13. The method of claim 12; wherein the polyethylene has:
(A) a melt flow index of 1.5 g/10 min to 2.1 g/10 min,
(B) a density of 0.91 g/cm³ to 0.93 g/cm²,
(G) a z-average molecular weight of 300,000 g/mol or greater, and
(H) a long chain branching (g′_{LCB}) value of 0.8 to 0.9.

14. The method of claim 13, wherein stretching is at a stretch ratio of 1 to 10.

15. The method of claim 12, wherein the polyethylene further has one or more of the following properties:
(I) a degree of shear thinning of 0.85 to 0.95,
a strain hardening ratio of 3 or greater,
(K) a melting temperature of 122° C. or greater,
(L) a crystallization temperature of 110° C. or greater,
(M) a Mw of 100,000 g/mol to 150,000 g/mol, and
(N) a Mw/Mn of 1 to 10.

16. The method of claim 12, wherein t polyethylene is present at 90 wt % to 100 wt % of the polymer melt.

17. The method of claim 12, wherein polymer melt further comprises an additive at 0.01 wt % to 1 wt % of film.

18. (canceled)

19. (canceled)

20. The method of claim 12, wherein the film has a thickness of 7 mils or less.

21. The method of claim 12, wherein the film further has one or more of the following properties:
(III) a 1% secant in the machine direction of 30,000 psi to 110,000 psi;
(IV) a yield strength in the machine direction of 500 psi to 10,000 psi;
(V) an elongation at yield in the machine direction of 5% to 15%;
(VI) a tensile strength in the machine direction of 5,500 psi to 25,000 psi;
(VII) a tensile strength per mil in the machine direction of 250 psi/mil to 4,000 psi/mil;
(VIII) an elongation at break in the machine direction of 60% to 450%;
(IX) an Elmendorf tear in the machine direction of 40 g to 1,500 g;
(X) an Elmendorf tear per mil in the machine direction of 5 g/mil to 150 g/mil; and
(XI) a shrink in the machine direction of 60% to 90%.

22. The method of claim 21, wherein the film further has one or more of the following properties:
(XII) a yield strength in the transverse direction of 1,000 psi to 1,500 psi;
(XIII) an elongation at yield in the transverse direction of 5% to 10%;
(XIV) a tensile strength in the transverse direction of 200 psi to 3,000 psi;
(XV) a tensile strength per mil in the transverse direction of 50 to 500 psi/mil;
(XVI) an elongation at break in the transverse direction of 300% to 1,200%;
(XVII) an Elmendorf tear in the transverse direction 1,500 g to 6,000 g;
(XVIII) an Elmendorf tear per mil in the transverse direction of 200 g to 700 g; and
(XIX) a shrink in the transverse direction of 10% to 40%.
